(19) United States
(12) Patent Application Publication
(10) Pub. No.: US 2005/0202380 A1
(43) Pub. Date: Sep. 15, 2005

(54) Personnel evaluation method, personnel evaluation system, personnel evaluation information processing unit, and personnel evaluation program

(75) Inventor: Shota Iwamoto, Kyoto (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Vitalknot, Kyoto-shi (JP)

(21) Appl. No.: 11/061,631

(22) Filed: Feb. 22, 2005

(30) Foreign Application Priority Data
Feb. 27, 2004 (JP) P2004-055349
Jan. 21, 2005 (JP) P2005-014856

(51) Int. Cl. G09B 19/00

(52) U.S. Cl. 434/238

(57) ABSTRACT

The personnel evaluation system that makes use of a terminal unit 1 having an input unit 1g as being an input element and an information processing unit 2 having an external memory unit 2c as being a memory element comprises a performance capability input receiving means 103 that receives an input of the job duty performance capability as being an evaluation of a performance capability of a work actually conducted during job duty through the input unit 1g, a performance capability digitalizing means 204 that digitalizes the job duty performance capability received by the performance capability input receiving means 103, a calculating means 205 that calculates an item evaluation value as being a value summed up a numerical value of the job duty performance capability digitalized by the performance capability digitalizing means 204 for each previously set item, an evaluation memorizing means 206 that memorizes the item evaluation value calculated by the calculating means 205 in relationship with an evaluation target person identifier showing an evaluation target person and an item identifier showing the item in a predetermined area of the external memorizing unit 2c, and an evaluation outputting means 207 that outputs the item evaluation value memorized in the evaluation memorizing means 206.

### BACKGROUND OF THE INVENTION AND RELATED ART STATEMENT

This invention relates to a personnel evaluation method used for evaluating human resources in mid-career recruitment or in companies or the like, a personnel evaluation system based on the personnel evaluation method, an information processing unit used for the personnel evaluation system, and a personnel evaluation program to operate the information processing unit.

Conventionally, in case of mid-career recruitment human resources in companies, recruitment is universally judged based on a job history, a personal career such as a professional achievement, a result of various types of vocational qualification tests of an applicant, and information on personality such as human nature obtained by an interview.

In addition, it has been known that data such as a career concerning human resources, skill, and a holding qualification is memorized in a server unit and the data is obtained through a communication line (For example, refer to patent document 1).

Patent document 1: Japan patent laid open number 2001-282938

Then in mid-career recruitment, a method of evaluating skill of the applicant has been mainly based on achievement or a job functional rank in last position at work. However, it has not been known that a method for objectively judging how much the estimated skill can be applied to skill concretely requited for a job duty of a job description as a target application.

Meanwhile, in evaluating human resources after joining a company, conventionally, a particular evaluating person such as an immediate supervisor has evaluated the human resources and items to be evaluated are not based on a performance capability of a concrete job duty work. Then there might be a problem that the evaluation by the particular evaluating person does not reflect the concrete skill required for the job duty due to arbitrariness of the evaluating person.

In addition, the arrangement described in the patent document 1 the skill is described by a numerical value. However, the numerical value is based on a past performance review and is not necessarily based on a performance capability of a concrete job duty work. More specifically, this arrangement does hot solve the above-mentioned problem that the evaluation might not reflect the concrete skill required for the job duty.

In order to solve the above-mentioned problems, the present claimed invention provides a means to judge a human resource which has skill concretely necessary for a job duty of a job description as a target application and to evaluate the human resource.

### SUMMARY OF THE INVENTION

More specifically, a personnel evaluation method in accordance with the present claimed invention is characterized by that, in order to classify a job duty of an evaluation target person into multiple items and to show skill of each item in a digitalized manner based on answered data that shows an answer to a questionnaire inquiring a performance capability of a job duty belonging to each item, an answer selected from data for answer that shows stepwise evaluation of a performance capability is set to be the answered data, the answered data is memorized in relationship with an item identifier that shows an item to which a job duty work inquired by the questionnaire belongs and an evaluation target person identifier that shows the evaluation target person, a job duty performance capability value corresponding to data for answer that coincides with the answered data is memorized in relationship with the answered data based on a relationship between the previously memorized data for answer and a job duty performance capability value as being digitalized data for answer, and an item evaluation value showing skill of the relevant item by summing up the job duty performance capability values related with an identical item identifier and an identical evaluation target person identifier is obtained.

In accordance with this method, since the selected input from the data for answer that shows stepwise evaluation of the performance capability is set to be the answered data, the data for answer is memorized in a job duty performance capability value correspondence memorizing means in relationship with the job duty performance value, and the job duty performance capability value corresponding to the data for answer that coincides with the answered data is related with the answered data, it is possible to certainly digitalize the answered data. In addition, since the input answered data is memorized in the answered data memorizing means in relationship with the item identifier that shows the item to which the job duty work inquired by the questionnaire belongs, the evaluation target person identifier that shows the evaluation target person, and the job duty performance capability value as being the digitalized answered data, and the item evaluation value is obtained in the digitalized manner by summing up the job duty performance capability values related with the identical item identifier and the identical evaluation target person identifier, it is possible to judge skill of the evaluation target person shown by the evaluation target person identifier that is required for the job duty of the item shown by each item identifier by a process that a evaluation conducting person refers the obtained evaluation item value.

In addition, as one example of a personnel evaluation system to actualize the personnel evaluation method, represented is a personnel evaluation system that makes use of a terminal unit having an input element and an information processing unit having a memory element, and that comprises a selected input receiving means that receives a selected input of the answered data showing an answer to the questionnaire inquiring a performance capability of a job duty work that belongs to each item through the input element, an answered data memorizing means that memorizes the answered data received by the selected input receiving means in relationship with an item identifier that shows an item to which the job duty work inquired by the questionnaire belongs and an evaluation target person identifier that shows an evaluation target person, a job duty performance capability value correspondence memorizing means that memorizes the data for answer in relationship with a job duty performance capability value as being digitalized data for answer, a job duty performance capability value digitalizing means that memorizes the job duty performance capability value corresponding to the data for answer that coincides with the answered data memorized in the answered data memorizing means in relationship with the answered data based on a memorized content of the job duty performance capability value correspondence memorizing means in the answered data memorizing means, an item evaluation value calculating means that obtains an item evaluation value by summing up the job duty performance capability values memorized in the answered data memorizing means in relationship with an identical evaluation target person identifier and an identical item identifier, an evaluation memorizing means that memorizes the item evaluation value obtained by the item evaluation value calculating means in relationship with the evaluation target person identifier and the item identifier, and an evaluation outputting means that outputs the item evaluation value memorized in the evaluation memorizing means.

As a concrete state to judge skill required for a routine work as being an obligatory job duty work that is generated on a daily bases for the evaluation target person, represented is that the item evaluation value calculating means obtains a routine work evaluation value that is obtained by summing up the job duty performance capability values in relationship with the item identifier showing that the questionnaire inquires the performance capability of the work concerning a routine work as an item evaluation value.

As a concrete state to judge skill required for a work concerning personal management for the evaluation target person, represented is that the item evaluation value calculating means obtains a personal management evaluation value that is obtained by summing up the job duty performance capability values in relationship with the item identifier showing that the questionnaire inquires the performance capability of the work concerning personal management as an item evaluation value. In this invention, “the work concerning personal management” is a concept including a job duty work concerning recruitment and acceptance of human resources, schedule management of a job duty, and service management.

As a concrete state to judge skill required for a work concerning a marketing and sales project for the evaluation target person, represented is that the item evaluation value calculating means obtains a marketing and sales project evaluation value that is obtained by summing up the job duty performance capability values in relationship with the item identifier showing that the questionnaire inquires the performance capability of the work concerning a marketing and sales project as an item evaluation value. In this invention, “the work concerning a marketing and sales project” is a concept including a work concerning sales promoting activities.

As a concrete state to judge skill required for a work concerning an industry inherent job duty for the evaluation target person, represented is that the item evaluation value calculating means obtains an industry inherent job duty evaluation value that is obtained by summing up the job duty performance capability values in relationship with the item identifier showing that the questionnaire inquires the performance capability of the work concerning an industry inherent job duty as an item evaluation value.

As a concrete state to judge skill required for a work concerning paperwork for the evaluation target person, represented is that the item evaluation value calculating means obtains paperwork evaluation value that is obtained by summing up the job duty performance capability values in relationship with the item identifier showing that the questionnaire inquires the performance capability of the work concerning paperwork as an item evaluation value.

As a concrete state to judge skill required for a work concerning risk management for the evaluation target person, represented is that wherein the item evaluation value calculating means obtains a risk management evaluation value that is obtained by summing up the job duty performance capability values in relationship with the item identifier showing that the questionnaire inquires the performance capability of the work concerning risk management as an item evaluation value.

As a state to make it possible to evaluate achievement to a level of the skill of each individual, represented is that wherein a ratio to ideal value calculating means that obtains a ratio of the item evaluation value to an ideal value coordinated with the evaluation target person identifier is further comprised. In accordance with this arrangement, it is possible to set an ideal value for each evaluation target person based on a job functional rank or the like, thereby enabling to provide an established degree of the skill according to a job functional rank as the ratio of the ideal value.

As an example to concretely actualize the personnel evaluation system, represented is that wherein an ideal value input receiving means that receives an input of the ideal value corresponding to each evaluation target person identifier is further comprised.

As another example to concretely actualize the personnel evaluation system, represented is a personnel evaluation system that is used for a state to coordinate the evaluation target person identifier with an attribute identifier that shows an attribute of the evaluation target person, and further comprising an ideal value attribute correspondence memorizing means that memorizes the ideal value in relationship with the attribute identifier and an ideal value setting means that coordinates the ideal value coordinated through the attribute identifier coordinated with the evaluation target person identifier, with the evaluation target person identifier.

In addition, as a state to make it possible to verify an established degree of the skill as a whole belonging to an identical job functional rank or an established degree of the skill as a whole belonging to an identical working place, represented is a personnel evaluation system that is used for a state to relate the evaluation target person identifier with the attribute identifier that shows the attribute of the evaluation target person and that further comprises an average ratio to ideal value by attribute calculating means that calculates an average of the ratio to the ideal value memorized in relationship with an identical attribute identifier and an identical item identifier. In accordance with the arrangement, it is possible for the average ratio to ideal value by attribute calculating means to calculate a mean value of the ratio to the ideal value for each item of the evaluation target person that belongs to the identical job functional rank or the identical working place.

As a state to make it possible to verity validity of the evaluation, represented is that the evaluation memorizing means memorizes an identical evaluation target person identifier and an identical item identifier in the memory element in relationship with multiple item evaluation values.

In accordance with the arrangement, it is possible to memorize, for example, the item evaluation value obtained based on self-judgment by the evaluation target person and the item evaluation value obtained based on judgment by a person such as a supervisor other than the evaluation target person for the item shown by the identical evaluation target person identifier and the identical item identifier in the evaluation memorizing means and to check them accordingly. It is a matter of course that the item evaluation values obtained based on the judgment by multiple persons other than the evaluation target person can be checked or the item evaluation value obtained based on the judgment by multiple persons other than the evaluation target person can be checked with the item evaluation value obtained based on the judgment by the evaluation target person. In addition, the item evaluation values obtained based on the judgment conducted in different days are memorized in the memory element, and growth and development of the evaluation target person can be judged.

As a state to make it possible to verify a tendency (soft or hard) of evaluation digitally, represented is that an evaluation value checking means that obtains a difference between two item evaluating values in relationship with the identical evaluation target person identifier and the identical item identifier is further comprised. In accordance with this arrangement, a difference between, for example, a digitalized value of self evaluation conducted by the evaluation target person himself or herself and a digitalized value of evaluation conducted by a person other than the evaluation target person such as a supervisor of the evaluation target person can be obtained.

As a state to make it possible to add a tinge of digitalized skill of a job duty of the applicant in mid-career recruitment by making use of a communication line such as the Internet, represented is a personnel evaluation system in which the terminal unit and the information processing unit are connected through a communication line, wherein the terminal unit comprises the input element, the selected input receiving means, and the transmitting means that transmits the answered data received by the selected input receiving means, and the information processing unit comprises the receiving means that receives the answered data, the answered data memorizing means, the job duty performance capability value correspondence memorizing means, the performance capability digitalizing means, the item evaluation value calculating means, the evaluation memorizing means, and the evaluation outputting means. In accordance with this arrangement, since the terminal unit and the information processing unit are connected through the communication line such as the Internet or an exclusive line, if the terminal unit is arranged at a side of, for example, an applicant of mid-career recruitment, the information processing unit is arranged at a side of a person who makes a decision to recruitment, the applicant inputs the answered data to the terminal unit, and the information processing unit outputs the item evaluation value calculated based on the answered data and memorized in the evaluation memorizing means, it is possible to judge the job duty skill of the applicant from the item evaluation value output by the information processing unit. In addition, in accordance with this arrangement, if the terminal unit is arranged at each working place and the information processing unit is arranged at a side of a person who conducts personnel ratings, and the answered data based on self evaluation by the evaluation target person himself or herself and/or based on judgment by an evaluation conducting person such as an immediate supervisor is input to the terminal unit and the information processing unit outputs the item evaluation value calculated based on the answered data and memorized in the evaluation memorizing means, it is possible to combine the item evaluation value with the personnel ratings.

Especially, if the terminal unit comprises a person specifying information receiving means that receives an input of person specifying information as being information to specify the applicant by making use of an inherent data and a person specifying auxiliary information receiving means that receives an input of person specifying auxiliary information as being information formed by enciphering the person specifying information, the transmitting means transmits the person specifying information and the person specifying auxiliary information together with the answered data, and the information processing unit further comprises a person specifying information reception judging means that judges whether the person specifying information and the person specifying auxiliary information are received or not and discontinues a subsequent process in case that both of the person specifying information and the person specifying auxiliary information are not received or either one of them is not received, the answered data is memorized in the information processing unit only at a time information that can specify an applicant is transmitted from the terminal unit to the information processing unit. As a result, mockery data can be prevented from being memorized in the information processing unit, thereby to improve credibility of the answered data.

Furthermore, if the person specifying information reception judging means discontinues a subsequent process only on occasions when neither the person specifying information nor the person specifying auxiliary information is received and the information processing unit comprises an answered data tentative memorizing means that memorizes the answered data received by the receiving means in relationship with the received person specifying information or the received person specifying auxiliary information in case of either one of the person specifying information and the person specifying auxiliary information is received, and the data checking means that transfers corresponding answered data in the answered data tentative memorizing means to the answered data memorizing means in case that both of the person specifying information and the person specifying auxiliary information are received, in case that the evaluation target person can transmit either one of the person specifying information and the person specifying auxiliary information for a certain reason, it is possible to memorize the answered data in the answered data tentative memorizing means and to ask the evaluation target person to anew transmit the person specifying information and the person specifying auxiliary information, thereby enabling to enhance convenience for the evaluation target person.

As a state to make it possible to certainly judge whether the performance capability of the job duty work is high or low, represented is that even-numbered versions of the data for answer are prepared. In case that odd-numbered versions, namely, 2n+1 (n is an integral number) versions of data for answer are prepared, multiple versions of answered data showing (n+1)th evaluation, namely, second for three-level evaluation, and third for five-level evaluation might be input in an attempt to show incapability of judgment that the performance capability is specially high or low. However, if the data for answer is prepared in even-numbered versions, it becomes impossible to input the data for answer that shows evaluation wherein the performance capability can not be judged to be specially high or low.

Furthermore, as one example of the information processing unit preferably used for the personnel evaluation method and the personnel evaluation system, represented is an information processing unit that has an answered data memorizing means that memorizes answered data showing an answer to questionnaires inquiring performance capability of a work actually conducted in a job duty of an evaluation target person in relationship with an item identifier showing an item to which a job duty work inquired by the questionnaire belongs and an evaluation target person identifier showing an evaluation target person, a job duty performance capability value correspondence memorizing means that memorizes the answered data in relationship with the job duty performance capability value as being digitalized answered data, a job duty performance capability digitalizing means that memorizes the answered data memorized in the answered data memorizing means in relationship with the job duty performance capability value corresponding to the answered data based on a memorized content of the job duty performance capability value correspondence memorizing means, an item evaluation value calculating means that obtains the item evaluation value by summing up job duty performance capability values in relationship with an identical evaluation target person identifier and an identical item identifier, and an evaluation memorizing means that memorizes the item evaluation value obtained by the item evaluation value calculating means in relationship with the evaluation target person identifier and the item identifier, and the answered data shows evaluation shown by the stepwise performance capability. In accordance with the information processing unit, it is possible to consistently conduct steps leading up to calculating the item evaluation value based on previously input answered data and memorizing it in the evaluation memorizing means.

In addition, as other example of the information processing unit preferably used for the personnel evaluation method and the personnel evaluation system, represented is an information processing unit that comprises a selected input receiving means that receives a selected input of answered data showing an answer to a questionnaire inquiring a performance capability of a work actually conducted during a job duty of an evaluation target person through an input element, an answered data memorizing means that memorizes the answered data received by the selected input receiving means in relationship with an item identifier that shows an item to which the job duty work inquired by the questionnaire belongs and an evaluation target person identifier that shows the evaluation target person, a job duty performance capability value correspondence memorizing means that memorizes the answered data in relationship with a job duty performance capability value as being digitalized answered data, a job duty performance capability value digitalizing means that memorizes the answered data memorized in the answered data memorizing means in relationship with the job duty performance capability value corresponding to the answered data in the answered data memorizing means based on a memorized content of the job duty performance capability value correspondence memorizing means, and an item evaluation value calculating means that obtains an item evaluation value by summing up the job duty performance capability values in relationship with an identical evaluation target person identifier and an identical item identifier in the answered data memorizing means, wherein the answered data shows evaluation shown by the stepwise performance capability. In accordance with the information processing unit, it is possible to consistently conduct steps of receiving the input of the answered data and of calculating the item evaluation value based on the received answered data.

If the above-mentioned information processing unit comprises a person specifying information reception judging means that judges whether person specifying information and person specifying auxiliary information are received or not and discontinues a subsequent process in case that both of the person specifying information and the person specifying auxiliary information are not received or either one of them is not received, the answered data is memorized only at a time the information that can specify an applicant is transmitted to the information processing unit. As a result, mockery data can be prevented from being memorized in the information processing unit, thereby to improve credibility of the answered data.

As mentioned above, in accordance with the personnel evaluation system of the present claimed invention, it is possible to certainly digitalize the answer to the questionnaire inquiring the performance capability of the job duty work. In addition, since the answered data is memorized in the answered data memorizing means in relationship with the item identifier that shows the item to which the work inquired by the questionnaire belongs, the evaluation target person identifier that shows the evaluation target person, and the job duty performance capability value as being the digitalized answered data, and the item evaluation value is obtained digitally by summing up the job duty performance capability values in relationship with the identical item identifier and the identical evaluation target person identifier, it is possible to judge the skill required for the job duty of the item shown by each item identifier of the evaluation target person shown by the evaluation target person identifier if the evaluation conducting person refers to the obtained evaluation item value. More specifically, it is possible to provide material to judge human resources having required skill in mid-career recruitment. In addition, it is possible to provide material to judge high-low of concrete skill required for the job duty of each individual and to evaluate and foster the human resources having the skill by reflecting the high-low of the skill on wage evaluation.

### BRIEF DESCRIPTION OF THE DRAWINGS

FIG. 1 is a general view showing a personnel evaluation system in accordance with a first embodiment of the present claimed invention.

FIG. 2 is a general view showing a configuration of a terminal unit in accordance with the first embodiment.

FIG. 3 is a general view showing a configuration of an information processing unit in accordance with the first embodiment.

FIG. 4 is a view showing a functional block of the personnel evaluation system in accordance with the first embodiment.

FIG. 5 is a view showing an example of an input receiving screen of the personnel evaluation system in accordance with the first embodiment.

FIG. 6 is a view showing a memorized state of answered data in an answered data memorizing means of the personnel evaluation system in accordance with the first embodiment.

FIG. 7 is a view showing memorized state of questionnaire data and an item identifier in an item correspondence memorizing means of the personnel evaluation system in accordance with the first embodiment.

FIG. 8 is a view showing a memorized state of data for answer and a job duty performance capability in a job duty performance capability correspondence memorizing means of the personnel evaluation system in accordance with the first embodiment.

FIG. 9 is a view showing a memorized state of an item evaluation value of the personnel evaluation system in accordance with the first embodiment.

FIG. 10 is a flow chart showing processes conducted by a terminal unit of the personnel evaluation system in accordance with the first embodiment.

FIG. 11 is a flow chart showing processes conducted by an information processing unit of the personnel evaluation system in accordance with the first embodiment.

FIG. 12 is a general view showing an information processing unit of the personnel evaluation system in accordance with a second embodiment of the present claimed invention.

FIG. 13 is a view showing a functional block of the personnel evaluation system in accordance with the second embodiment.

FIG. 14 is a view showing a memorized state of answered data of the personnel evaluation system in accordance with the second embodiment.

FIG. 15 is a view showing a memorized state of an item evaluation value of the personnel evaluation system in accordance with the second embodiment.

FIG. 16 is a view showing a configuration of an ideal value input receiving means of the personnel evaluation system in accordance with the second embodiment.

FIG. 17 is a view showing a memorized state of an ideal answered data of the personnel evaluation system in accordance with the second embodiment.

FIG. 18 is a view showing a memorized state of the ideal value of the personnel evaluation system in accordance with the second embodiment.

FIG. 19 is a flow chart showing processes conducted by an information processing unit of the personnel evaluation system in accordance with the second embodiment.

FIG. 20 is a flow chart showing processes conducted by the information processing unit of the personnel evaluation system in accordance with the second embodiment.

FIG. 21 is a flow chart showing processes conducted by the information processing unit of the personnel evaluation system in accordance with the second embodiment.

FIG. 22 is a view showing a functional block of a terminal unit used for a personnel evaluation system in accordance with other embodiment of the present claimed invention.

FIG. 23 is a view showing a functional block of an information processing unit used for the personnel evaluation system in accordance with the other embodiment of the present claimed invention.

FIG. 24 is a view showing a functional block of an information processing unit used for the personnel evaluation system in accordance with the other embodiment of the present claimed invention.

FIG. 25 is a view showing a memorized state of an evaluation target person identifier and an attribute identifier in the personnel evaluation system in accordance with the other embodiment of the present claimed invention.

FIG. 26 is a view showing a memorized state of an attribute identifier and an ideal value in the personnel evaluation system in accordance with the other embodiment of the present claimed invention.

FIG. 27 is a flow chart showing processes conducted by the information processing unit of the personnel evaluation system in accordance with the other embodiment of the present claimed invention.

FIG. 28 is a view showing a functional block of a personnel evaluation system in accordance with the other embodiment of the present claimed invention.

FIG. 29 is a view showing a memorized state of a company identifier and an item evaluation gravity of the personnel evaluation system in accordance with this embodiment.

FIG. 30 is a view showing a flow of processes conducted by a terminal unit of the personnel evaluation system in this embodiment.

FIG. 31 is a view showing a flow of processes conducted by an information processing unit of the personnel evaluation system in this embodiment.

FIG. 32 is a view showing a functional block of a terminal unit used for a personnel evaluation system in accordance with other embodiment of the present claimed invention.

FIG. 33 is a view showing a functional block of the personnel evaluation system in accordance with this embodiment.

FIG. 34 is a view showing a flow of processes conducted by a terminal unit of the personnel evaluation system in this embodiment.

FIG. 35 is a view showing a flow of processes conducted by an information processing unit of the personnel evaluation system in this embodiment.

FIG. 36 is a view showing a flow of processes conducted by a terminal unit of the personnel evaluation system in this embodiment.

FIG. 37 is a view showing a flow of processes conducted by an information processing unit of the personnel evaluation system in this embodiment.

### DETAILED DESCRIPTION OF THE PREFERRED EMBODIMENTS

A first embodiment of the present claimed invention will be described in detail by reference to the accompanying drawings.

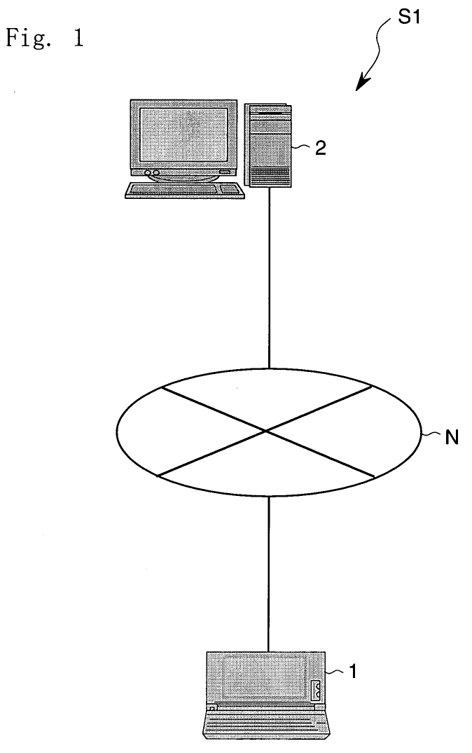

A personnel evaluation system S1 in accordance with this embodiment, an outline of which is shown in FIG. 1, is arranged by connecting a terminal unit 1 and an information processing unit 2 through a communication line N and used mainly in case of mid-career recruitment.

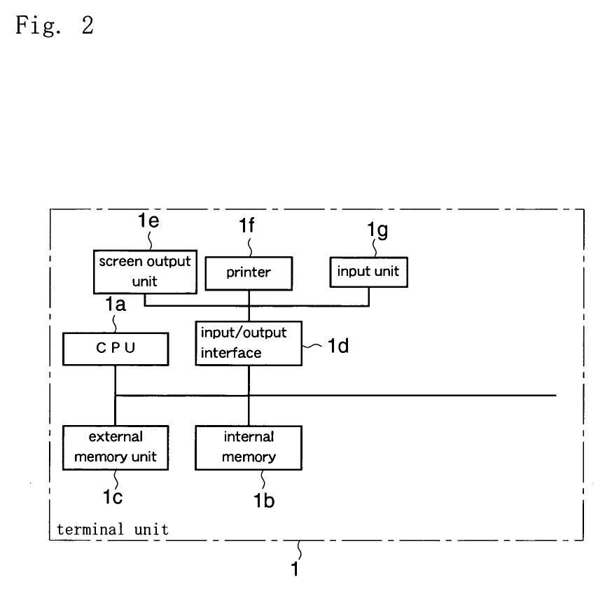

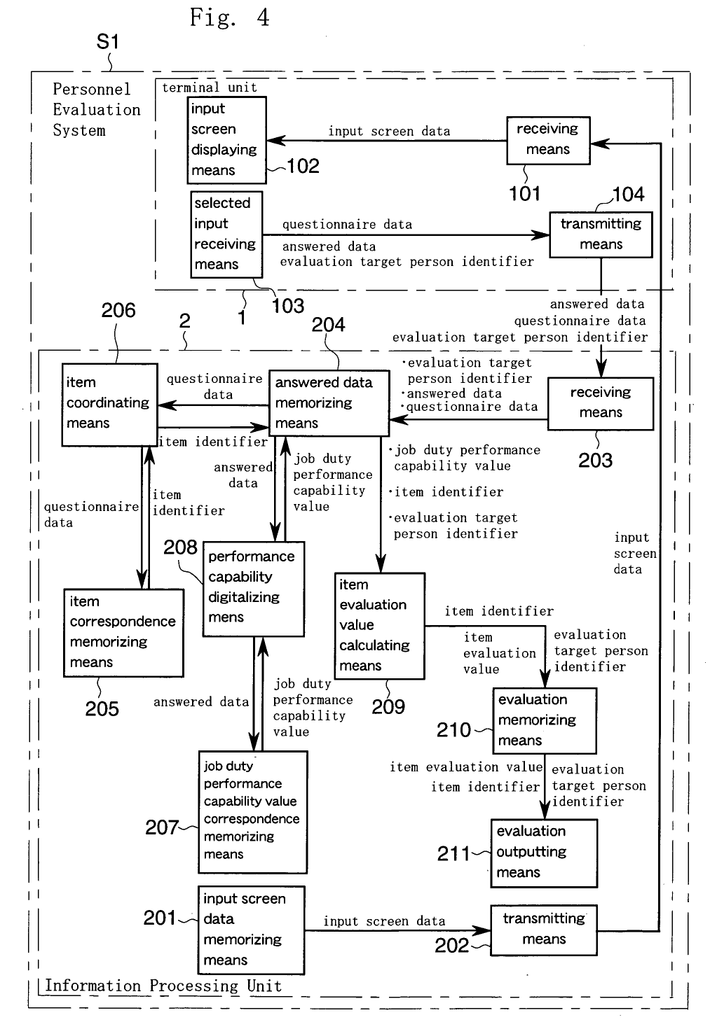

The terminal unit 1 is arranged at a side of an applicant for mid-career recruitment. The terminal unit 1, whose configuration is shown in FIG. 2, has a CPU 1a, an internal memory 1b, an external memory unit 1c and an input/output interface 1d, and peripheral devices such as a screen output unit 1e, a printer 1f, and an input unit 1g are connected to the input/output interface 1d. Furthermore, the terminal unit 1 is connected to the communication line N through the input/output interface 1d. The terminal unit 1 has a function as a general personal computer. In addition, the CPU 1a executes a program memorized in the external memory unit 1c and functions as a receiving means 101, an input screen displaying means 102, a selected input receiving means 103, and a transmission means 104, as shown in FIG. 4. A keyboard, a mouse and a touch panel are conceived as the input unit 1g.

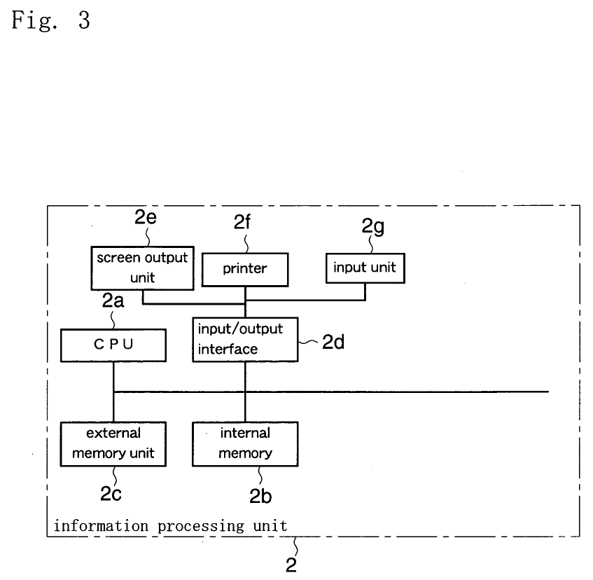

The information processing unit 2 is arranged at a side of recruitment for mid-career recruitment. The information processing unit 2, whose configuration is shown in FIG. 3, has a CPU 2a, an internal memory 2b, an external memory unit 2c and an input/output interface 2d, and peripheral devices such as a screen output unit 2e, a printer 2f, and an input unit 2g are connected to the input/output interface 2d. Furthermore, the information processing unit 2 is connected to the communication line N through the input/output interface 2d. In addition, the information processing unit 2 has a function as a general server computer. The CPU 2a executes a program memorized in the external memory unit 2c and functions as an input screen data memorizing means 201, a transmitting means 202, a receiving means 203, an answered data memorizing means 204, an item correspondence memorizing means 205, an item coordinating means 206, a job duty performance capability value correspondence memorizing means 207, a performance capability digitalizing means 208, an item evaluation value calculating means 209, an evaluation memorizing means 210, and an evaluation outputting means 211, as shown in FIG. 4. A keyboard, a mouse and a touch panel are conceived as the input unit 2g.

The receiving means 101 receives input screen data as being data to display an input screen to promote an applicant to input answered data showing an answer to a questionnaire inquiring a performance capability of a job duty work from the information processing unit 2.

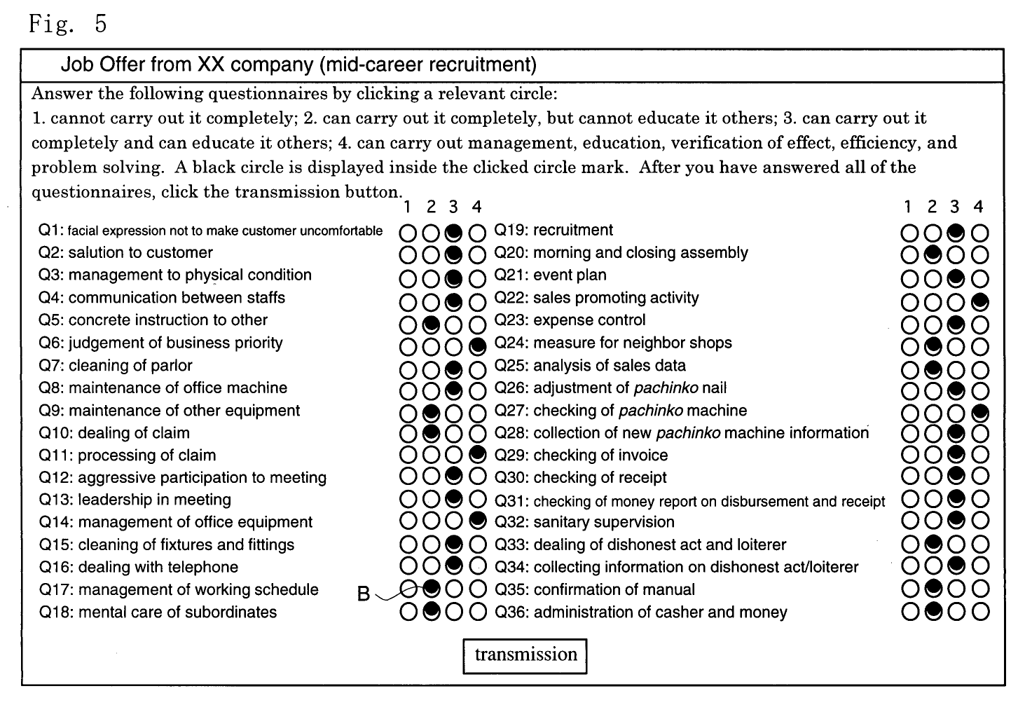

The input screen displaying means 102 receives the input screen data from the receiving means 101 and visibly displays the input screen, as shown in FIG. 5, by making use of the screen output unit 1e. More concretely, questionnaires inquiring a performance capability of a job duty work stepwise and data for answer that shows stepwise evaluation of a job duty performance capability for the evaluation target person are displayed for each job duty work. In this embodiment, the data for answer has four kinds; “1” that shows the evaluation target person can not carry out the inquired job duty work completely, “2” that shows the evaluation target person can carry out the inquired job duty work completely, however the person can not educate others about the work, “3” that shows the evaluation target person can carry out the inquired job duty work completely and can educate others about the work, and “4” that shows the evaluation target person can carry out management and education of the inquired job duty, other schedule management, verification of effect and efficiency, and problem-solving. The questionnaires shown in FIG. 5 are represented as an example of a case of pachinko parlors.

The selected input receiving means 103 receives an input of answered data and an evaluation target person identifier showing an applicant through the input unit 1g as being an input element. More concretely, the selected input receiving means 103 promotes the evaluation target person to check the data for answer corresponding to the stepwise evaluation as an answer to the questionnaire, more specifically, promotes a selected input and passes the checked data for answer as the answered data to the transmitting means 104. In this embodiment, checking the data for answer is conducted by clicking a corresponding circle mark displayed at a side of the data for answer on an input screen. Furthermore, as shown in FIG. 5, a black circle is displayed inside the checked circle mark on the input screen so as to visibly display that the data for answer has been checked.

The transmission means 104 receives an order to transmit the answered data and transmits the answered data received by the selected input receiving means 103 in relationship with the evaluation target person identifier showing the applicant and the questionnaire data showing the questionnaire corresponding to the answer shown by the answered data to the information processing unit 2 through the input/output interface 1d. The evaluation target person identifier can be, for example, a mailing address of the applicant, however, it may not necessarily be the mailing address of the applicant but a combination of a name and a date of birth of the applicant as far as the applicant can be uniquely identified. In addition, in this embodiment, the order to transmit the answered data is conducted by receiving a click to a transmission order receiving button B on the input screen.

The input screen data memorizing means 201 memorizes the input screen data in a predetermined area of the external memory unit 2c.

The transmitting means 202 transmits the input screen data memorized in the input screen data memorizing means 201 to the terminal unit 1 through the input/output interface 2d.

The receiving means 203 receives the answered data, the evaluation target person identifier, and the questionnaire data transmitted from the transmitting means 104 of the terminal unit 1 through the input/output interface 2d.

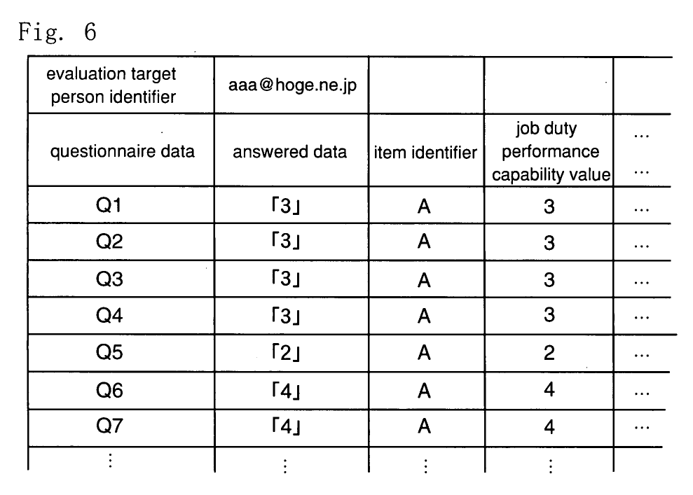

The answered data memorizing means 204 memorizes the answered data, the evaluation target person identifier, and the questionnaire data that are received by the receiving means 203 in a related state in a predetermined area of the internal memory 2b and the external memory unit 2c in a state shown in FIG. 6.

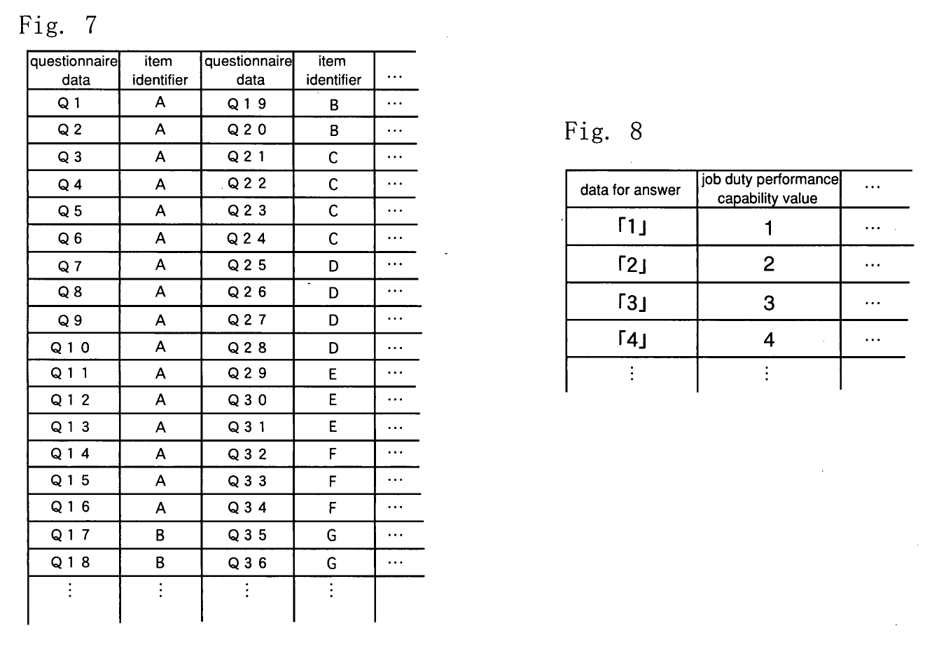

The item correspondence memorizing means 205 memorizes the questionnaire data and the item identifier showing the item to which the job duty work that the questionnaires inquire belongs in a related state in a predetermined area of the external memory unit 2c in a state shown in FIG. 7.

The item coordinating means 206 memorizes the item identifier corresponding to the questionnaire data memorized in the answered data memorizing means 204 in relationship with the questionnaire data by reference to the memorized contents of the item correspondence memorizing means 205 in the answered data memorizing means 204.

The job duty performance capability value correspondence memorizing means 207 memorizes “1”, “2”, “3”, and “4” as being data for answer in relationship with the job duty performance capability value in a predetermined area of the external memory unit 2c in a state shown in FIG. 8.

The performance capability digitalizing means 208 memorizes the job duty performance capability value corresponding to the data for answer that coincides with the answered data memorized in the answered data memorizing means 204 based on the memorized content of the job duty performance capability value correspondence memorizing means 207 in relationship with the answered data in the answered data memorizing means 204. More specifically, the answered data memorizing means 204 memorizes the item identifier corresponding to the questionnaire data and the job duty performance capability value corresponding to the answered data in a mutually related state, in addition to the above-mentioned answered data, the evaluation target person identifier and the questionnaire data.

The item evaluation value calculating means 209 sums up the job duty performance capability values memorized in the answered data memorizing means 204 in relationship with an identical evaluation target person identifier and an identical item identifier and obtains the item evaluation value. In this embodiment, job duty work is classified into seven items; routine work, personal administration, marketing and sales project, job duty specific to an industry, paperwork, risk management, and others. The routine work is allocated with an item identifier “A”, the personal administration with an item identifier “B”, the marketing and sales project with an item identifier “C”, the job duty specific to an industry, in this embodiment, a pachinko parlor with an item identifier “D”, the paperwork with an item identifier “E”, the risk management with an item identifier “F”, and the others with an item identifier “G” respectively. Each item evaluation value for the above-mentioned seven items is calculated by summing up job duty performance capability values associated through the performance capability digitalizing means 208 with the answered data of the questionnaire inquiring a performance capability of the job duty work classified into the seven items. More specifically, in this embodiment, each of the routine work in relationship with the item identifier “A”, the personal administration with the item identifier “B”, the marketing and sales project with the item identifier “C”, the job duty specific to an industry with the item identifier “D”, the paperwork with the item identifier “E”, the risk management with the item identifier “F”, and the others with the item identifier “G” is calculated respectively as the item evaluation value.

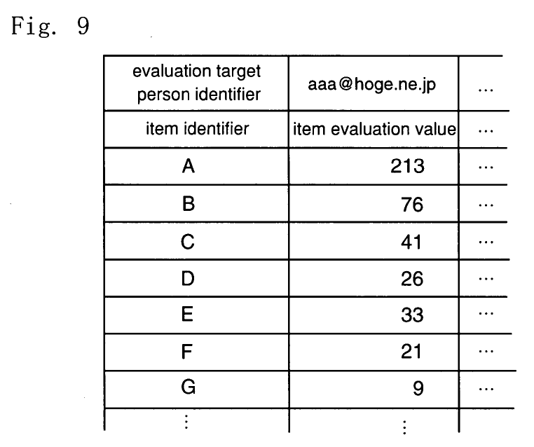

The evaluation memorizing means 210 memorizes the item evaluation value calculated by the item evaluation value calculating means 209 in relationship with the evaluation target person identifier showing the evaluation target person and the item identifier showing the item in a predetermined area of the external memory unit 2c as being the memory element, as shown in FIG. 9.

The evaluation outputting means 211 outputs the item evaluation value memorized in the evaluation memorizing means 210 through the screen output unit 2e.

Next, a flow in case of mid-career recruitment by making use of this personnel evaluation system will be explained by reference to the drawings.

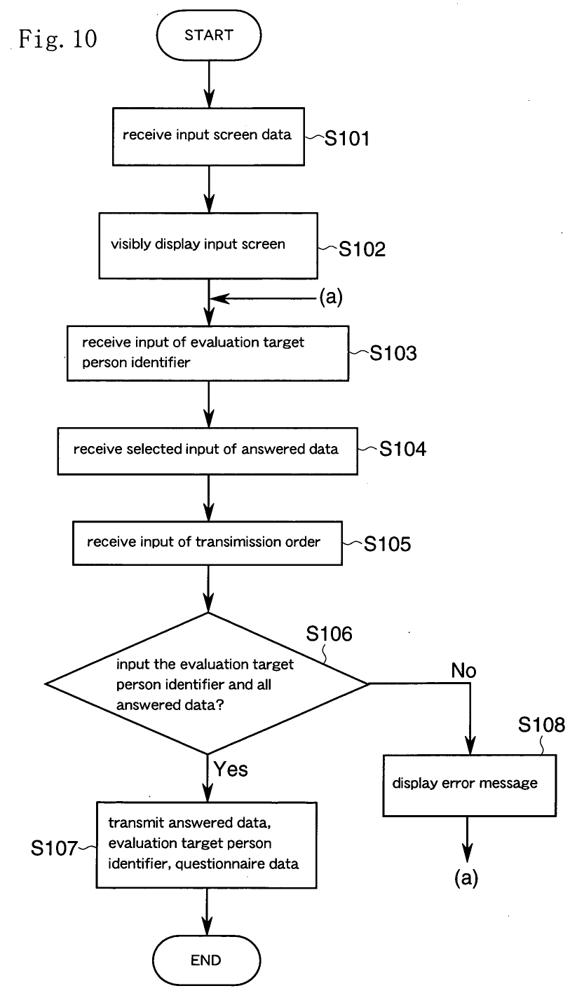

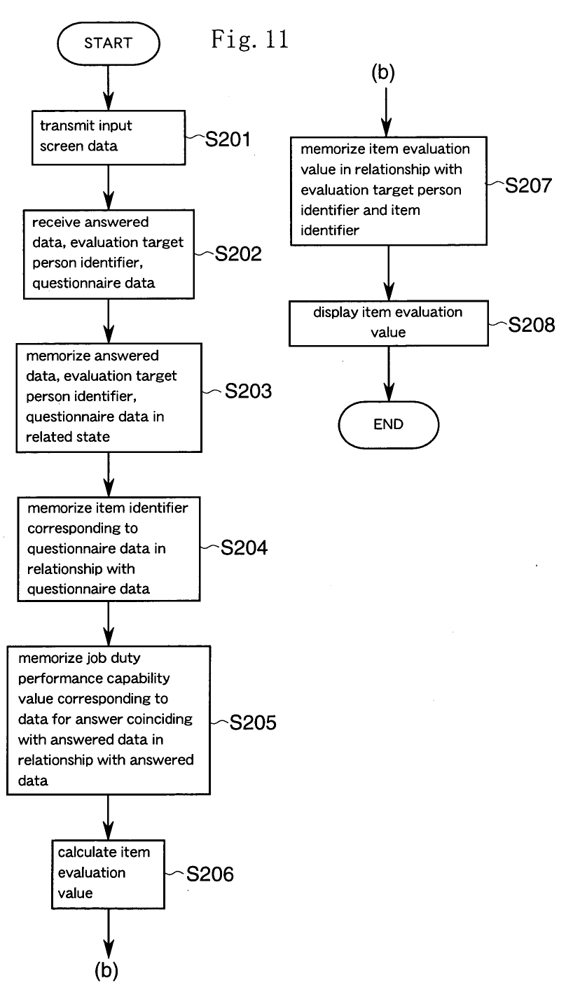

The applicant has access to a recruiting site by the use of the terminal unit 1. In this case, a flow of processes that the terminal unit 1 conducts will be explained by reference to FIG. 10. First, receive the input screen data (S101), and visibly display the input screen based on the input screen data (S102). Then receive an input of the evaluation target person identifier by the applicant (S103), and receive a selected input of the answered data for each job duty by the applicant (S104). Then receive the input of transmission order (S105). In this case, judge whether or not the evaluation target person identifier and all of the answered data are input (S106), in case that the evaluation target person identifier and all of the answered data are input, transmit the received answered data to the information processing unit 2 together with the evaluation target person identifier showing the applicant and the questionnaire data showing the questionnaires (S107). In case that the evaluation target person identifier and all of the answered data are not input, display an error message to promote an input of all the answered data (S108), and return to the step that receives an input of the evaluation target person identifier (S103). Then the process is completed.

The information processing unit 2 conducts successive processes whose flow is shown in FIG. 11. More concretely, transmit the input screen data to the terminal unit 1 in accordance with access to the recruiting site (S201), and receive the answered data, the evaluation target person identifier, and the questionnaire data from the terminal unit 1 (S202). Then memorize the answered data, the evaluation target person identifier, and the questionnaire data in a related state in the answered data memorizing means 204 (S203). Next, memorize the item identifier corresponding to the received questionnaire data in relationship with the questionnaire data in the answered data memorizing means 204 (S204). Furthermore, memorize the job duty performance capability value corresponding to the received answered data in the answered data memorizing means 204 in relationship with the answered data (S205). Next, obtain the item evaluation value by summing up the job duty performance capability values memorized in relationship with the identical evaluation target person identifier and the identical item identifier (S206), and memorize the obtained item evaluation value in relationship with the evaluation target person identifier and the item identifier in the evaluation memorizing means 210 (S207). Later, output and visibly display the item evaluation value memorized in the step S207 (S208).

As mentioned above, it is possible for the personnel evaluation system S1 in accordance with this embodiment to judge the skill and merit and demerit of the evaluation target person necessary for each job duty of the evaluation target person, namely, of the applicant by inputting the job performance capability for each job duty, digitalizing the input job performance capability and summing up the digitalized job duty performance capability for each item so as to calculate the item evaluation value. More specifically, in mid-career recruitment, it is possible to provide material that will help judge human resources having necessary skill.

Furthermore, since the item evaluation value calculating means 209 obtains the routine work evaluation value that is obtained by summing up the job duty performance capability values in relationship with the item identifier showing that the questionnaire inquiring the performance capability of the work concerning a routine work, the personal management value that is obtained by summing up the job duty performance capability values in relationship with the item identifier showing that the questionnaire inquiring the performance capability of the work concerning personal management, the marketing and sales project evaluation value that is obtained by summing up the job duty performance capability values in relationship with the item identifier showing that the questionnaire inquiring the performance capability of the work concerning a marketing and sales project, the industry inherent job duty evaluation value that is obtained by summing up the job duty performance capability values in relationship with the item identifier showing that the questionnaire inquiring the performance capability of the work concerning an industry inherent job duty, the paperwork evaluation value that is obtained by summing up the job duty performance capability values in relationship with the item identifier showing that the questionnaire inquiring the performance capability of the work concerning paperwork, and the risk management evaluation value that is obtained by summing up the job duty performance capability values in relationship with the item identifier showing that the questionnaire inquiring the performance capability of the work concerning risk management respectively, it is possible to judge whether or not the applicant has the concrete skill and to judge merit of the applicant with reference to the digitally shown item evaluation value of the skill of each item necessary for the job duty as being a target to apply.

In addition, in this embodiment, since the terminal unit 1 is arranged at a side of the applicant and the information processing unit 2 is arranged at a side of the recruiter and the terminal unit 1 and the information processing unit 2 are connected by the communication line N, it is possible to make a selection in recruitment by adding a tinge of evaluation of skill necessary for the job duty as being a target of recruitment through on-line recruitment by the use of the Internet or the like. Furthermore, the evaluation of skill can be conducted in line with the actually conducted job duty work.

Next, a second embodiment of the present claimed invention will be described in detail by reference to the accompanying drawings.

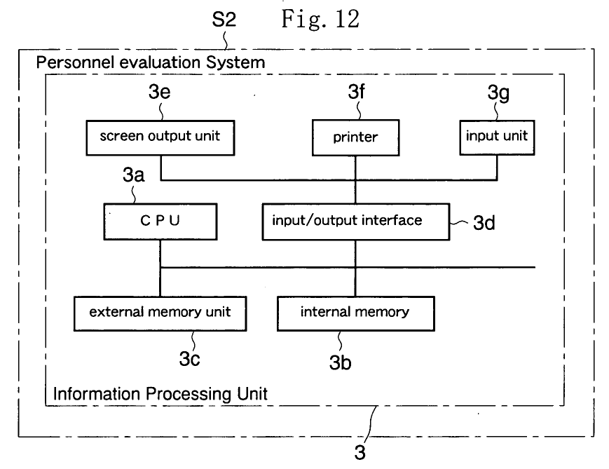

A personnel evaluation system S2 in accordance with this embodiment executes a personnel evaluation program in an information processing unit 3 whose internal configuration is shown in FIG. 12.

The information processing unit 3 has, as shown in FIG. 12, a CPU 3a, an internal memory 3b, an external memory unit 3c and an input/output interface 3d, and peripheral devices such as a screen output unit 3e, a printer 3f, and an input unit 3g are connected to the input/output interface 3d. In addition, the information processing unit 3 has a function as a general personal computer. The information processing unit 3 has functions as a terminal unit and an information processing unit descried in claims.

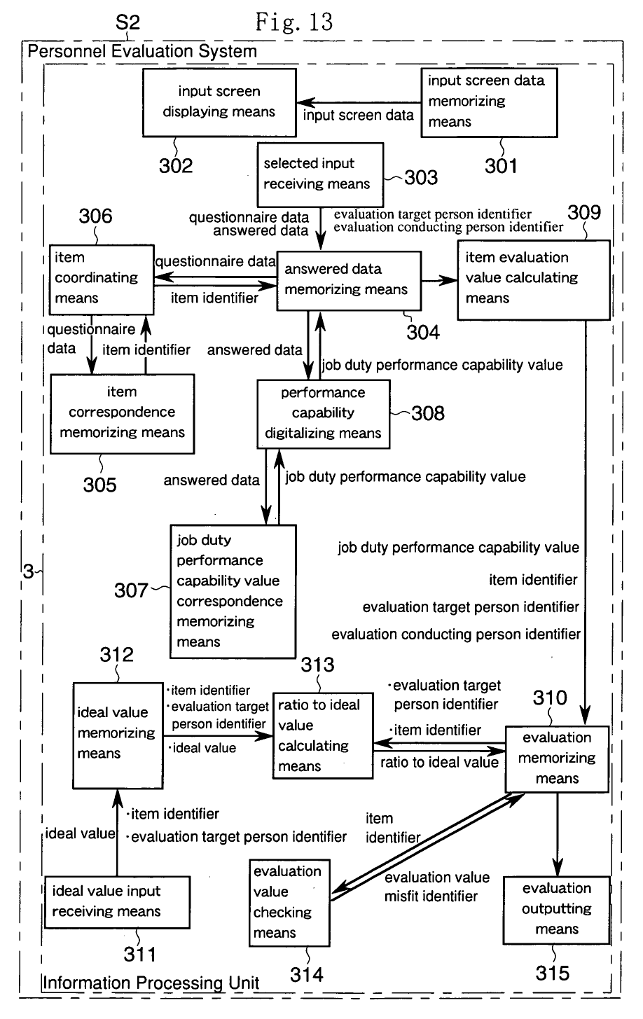

In this embodiment, the information processing unit 3 executes a personnel evaluation program memorized in the external memory unit 3c and functions as, as shown in FIG. 13, an input screen data memorizing means 301, an input screen displaying means 302, a selected input receiving means 303, an answered data memorizing means 304, an item correspondence memorizing means 305, an item coordinating means 306, a job duty performance capability value correspondence memorizing means 307, a performance capability digitalizing means 308, an item evaluation value calculating means 309, an evaluation memorizing means 310, an ideal value input receiving means 311, an ideal value memorizing means 312, a ratio to ideal value calculating means 313, an evaluation value checking means 314, and an evaluation outputting means 315.

The input screen data memorizing means 301 memorizes the input screen data as being data to display an input screen to promote an applicant to input answered data showing an answer to a questionnaire inquiring a performance capability of a job duty work in a predetermined area of the external memory unit 3c.

The input screen displaying means 302 receives the input screen data from the input screen data memorizing means 301 and visibly displays the input screen by making use of the screen output unit 3e. The input screen is the same as the input screen shown in FIG. 5 in the first embodiment. More concretely, questionnaires inquiring a performance capability of a job duty work stepwise and data for answer that shows stepwise evaluation of a job duty performance capability for the evaluation target person are displayed for each job duty work. In this embodiment, the data for answer has four kinds; “1” that shows the evaluation target person can not carry out the performance of the inquired job duty completely, “2” that shows the evaluation target person can carry out the performance of the inquired job duty completely, however the person can not educate others about the performance, “3” that shows the evaluation target person can carry out the performance of the inquired job duty completely and can educate others about the performance, and “4” that shows the evaluation target person can carry out management and education of the inquired job duty, other schedule management, verification of effect and efficiency, and problem-solving.

The selected input receiving means 303 receives an input of answered data, an evaluation target person identifier showing an evaluation target person, and an evaluation conducting person identifier showing a person who conducts evaluation through the input unit 3g as being an input element. More concretely, the selected input receiving means 303 promotes the evaluation target person to check the data for answer corresponding to the stepwise evaluation as an answer to the questionnaire, and passes the checked data for answer as the answered data to the answered data memorizing means 304. In this embodiment, checking the data for answer is conducted by clicking a corresponding circle mark displayed at a side of the data for answer on an input screen. Furthermore, as shown in FIG. 5, a black circle is displayed inside the checked circle mark on the input screen so as to visibly display that the data for answer has been checked.

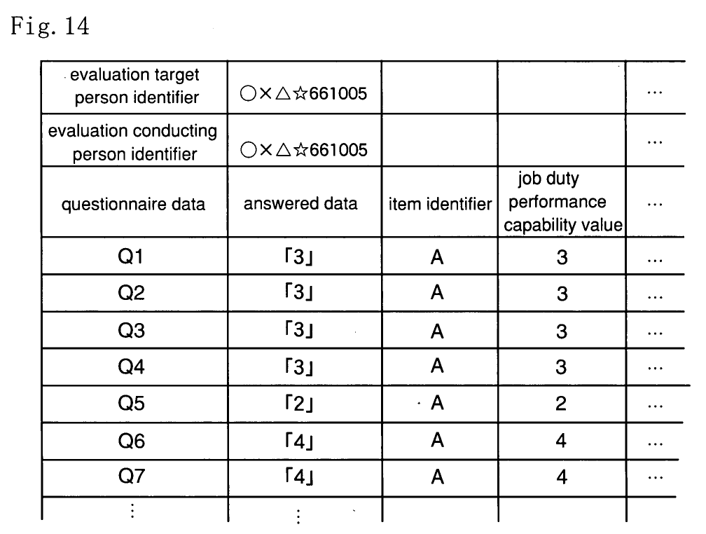

The answered data memorizing means 304 memorizes the answered data, the evaluation target person identifier, the questionnaire data showing questionnaires corresponding to the answer shown by the answered data, and the evaluation conducting person identifier in a related state in a predetermined area of the internal memory 3b or the external memory unit 3c in a state shown in FIG. 14.

The item correspondence memorizing means 305 memorizes the questionnaire data and the item identifier showing the item to which the job duty work that the questionnaires inquire belongs in a related state in a predetermined area of the external memory unit 3c. A memorized state of the questionnaire data and the item identifier in the item correspondence memorizing means 305 is the same as the state in the item correspondence memorizing means 205 in the first embodiment, namely, shown in FIG. 7.

The item coordinating means 306 memorizes the item identifier corresponding to the questionnaire data memorized in the answered data memorizing means 304 in relationship with the questionnaire data in the answered data memorizing means 304 by reference to the memorized contents of the item correspondence memorizing means 305.

The job duty performance capability value correspondence memorizing means 307 memorizes the data for answer in relationship with the job duty performance capability value in a predetermined area of the external memory unit 3c. A memorized state of the data for answer and the job duty performance capability value in the job duty performance capability value correspondence memorizing means 307 is the same as the state in the job duty performance capability value correspondence memorizing means 207 in the above-mentioned first embodiment, namely, shown in FIG. 8.

The performance capability digitalizing means 308 memorizes the job duty performance capability value corresponding to the answered data memorized in the answered data memorizing means 304 based on the memorized content of the job duty performance capability value correspondence memorizing means 307 in relationship with the answered data in the answered data memorizing means 304. More specifically, the answered data memorizing means 304 memorizes the item identifier corresponding to the questionnaire data and the job duty performance capability value corresponding to the answered data in a mutually related state, in addition to the above-mentioned answered data, the evaluation target person identifier, the questionnaire data and the evaluation conducting person identifier.

The item evaluation value calculating means 309 sums up the job duty performance capability values memorized in the answered data memorizing means 304 in relationship with an identical evaluation target person identifier, an identical item identifier, and an identical evaluation conducting person identifier, and obtains the item evaluation value for each item identifier. In this embodiment, job duty work is classified into seven items; routine work, personal administration, marketing and sales project, job duty specific to an industry, paperwork, risk management, and others. The routine work is allocated with an item identifier “A”, the personal administration with an item identifier “B”, the marketing and sales project with an item identifier “C”, the job duty specific to an industry, in this embodiment, a pachinko parlor with an item identifier “D”, the paperwork with an item identifier “E”, the risk management with an item identifier “F”, and the others with an item identifier “G” respectively. Each item evaluation value for the above-mentioned seven items is calculated by summing up job duty performance capability values associated through the performance capability digitalizing means 308 with the answered data of the questionnaire inquiring a performance capability of the job duty work classified into the seven items. More specifically, in this embodiment, each of the routine work in relationship with the item identifier “A”, the personal administration with the item identifier “B”, the marketing and sales project with the item identifier “C”, the job duty specific to an industry with the item identifier “D”, the paperwork with the item identifier “E”, the risk management with the item identifier “F”, and the others with the item identifier “G” is calculated respectively as the item evaluation value.

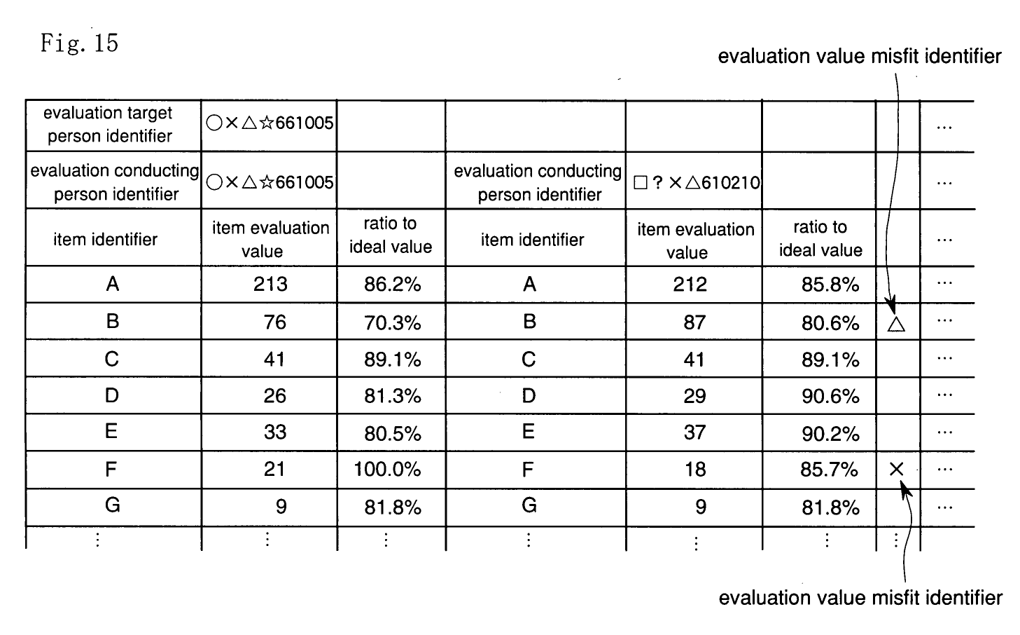

The evaluation memorizing means 310 memorizes the item evaluation value in relationship with the evaluation target person identifier, the item identifier, and the evaluation conducting person identifier in a predetermined area of the external memory unit 3c in a state shown in FIG. 15. Furthermore, in this embodiment, a ratio to an ideal value and an evaluation value misfit identifier, to be described later, are also memorized in relationship with the evaluation target person identifier in a predetermined area of the external memory unit 3c in a state shown in FIG. 15.

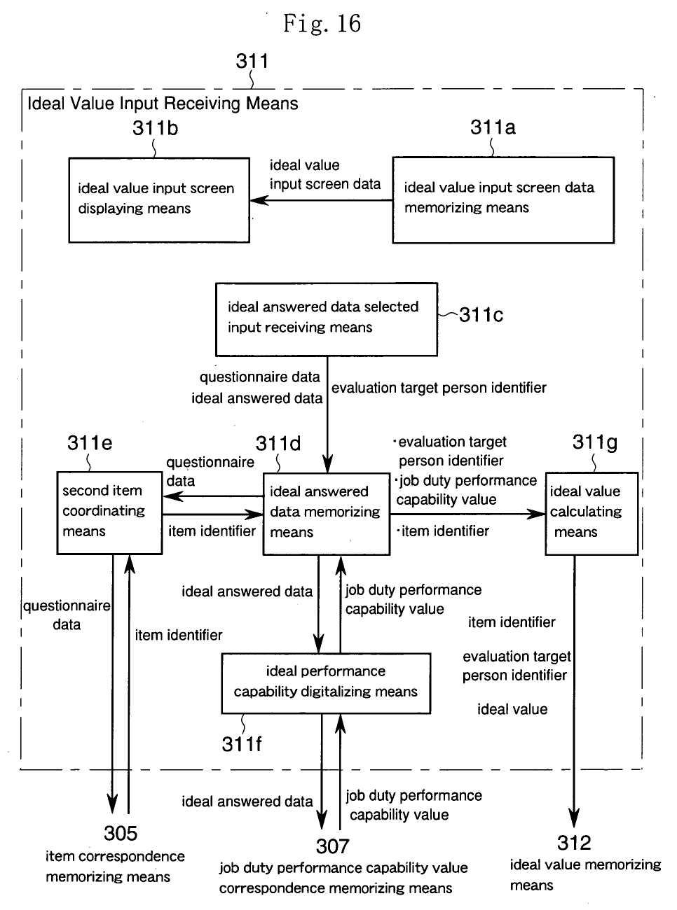

The ideal value input receiving means 311 receives the evaluation target person identifier showing the evaluation target person and an input of the ideal value corresponding to the evaluation target person through the input unit 3g as being the input element. The ideal value is a value that has been set previously for each evaluation target person and for each item. More concretely, the ideal value is a total sum of the job duty performance capability values necessary for each evaluation target person for the job duty work that belongs to each item. In this embodiment, the ideal value input receiving means 311 has, as shown in FIG. 16, an ideal value input screen data memorizing means 311a, an ideal value input screen displaying means 311b, an ideal answered data selected input receiving means 311c, an ideal answered data memorizing means 311d, a second item coordinating means 311e, an ideal performance capability value digitalizing means 311f, and an ideal value calculating means 311g.

The ideal value input screen data memorizing means 311a memorizes the ideal value input screen data as being data to display an ideal value input screen to promote the evaluation target person to input ideal answered data showing an answer to a questionnaire inquiring a performance capability of a job duty work necessary for the evaluation target person in a predetermined area of the external memory unit 3c.

The ideal value input screen displaying means 311b receives the ideal value input screen data from the ideal value input screen data memorizing means 311a, and visibly displays the input screen by making use of the screen output unit 3e. The input screen is the same as the input screen shown in FIG. 5 in the first embodiment.

The ideal answered data selected input receiving means 311c receives an input of the ideal answered data and the evaluation target person identifier showing the evaluation target person through the input unit 3g as being an input element. More concretely, the ideal answered data selected input receiving means 311c has the same functions and arrangement as the above-mentioned selected input receiving means 303 except for passing the checked data for answer as the ideal answered data to the ideal answered data memorizing means 311 and except for not receiving input of the evaluation conducting person identifier.

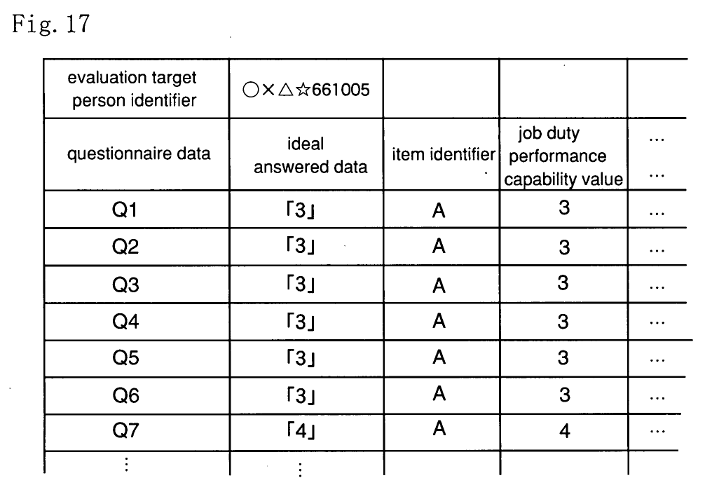

The ideal answered data memorizing means 311d memorizes the ideal answered data, the evaluation target person identifier, and the questionnaire data showing questionnaires corresponding to the answer shown by the ideal answered data in a related state in a predetermined area of the internal memory 3b and the external memory unit 3c in a state shown in FIG. 17.

The second item coordinating means 311e memorizes the item identifier corresponding to the questionnaire data memorized in the ideal answered data memorizing means 311d in relationship with the questionnaire data by reference to the memorized contents of the item correspondence memorizing means 305 in the ideal answered data memorizing means 311d.

The ideal performance capability value digitalizing means 311f memorizes the job duty performance capability value corresponding to the ideal answered data memorized in the ideal answered data memorizing means 311d based on the memorized content of the job duty performance capability value correspondence memorizing means 307 in relationship with the ideal answered data in the ideal answered data memorizing means 311d. More specifically, the ideal answered data memorizing means 311d memorizes the item identifier corresponding to the questionnaire data and the job duty performance capability value corresponding to the ideal answered data in a mutually related state, in addition to the above-mentioned ideal answered data, the evaluation target person identifier, and the questionnaire data.

The ideal value calculating means 311g sums up the job duty performance capability values memorized in relationship with an identical evaluation target person identifier and an identical item identifier in the ideal answered data memorizing means 311d and obtains the ideal value.

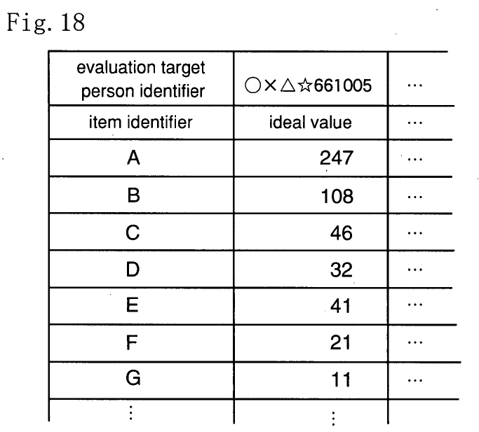

The ideal value memorizing means 312 memorizes the ideal value received by the ideal value input receiving means 311 in relationship with the evaluation target person identifier showing the evaluation target person and the item identifier showing the item in a predetermined area of the external memory unit 3c in a state shown in FIG. 18.

The ratio to ideal value calculating means 313 obtains an ideal ratio as being a ratio to the ideal value memorized in the evaluation memorizing means 310 for each item evaluation value and each evaluation target person.

The evaluation value checking means 314 obtains a difference between two item evaluation values for an identical evaluation target person identifier and an identical item identifier. In this embodiment, in case that an absolute value of a difference between the two item evaluation values equals to or over a predetermined value, the evaluation value misfit identifier is associated with the evaluation target person identifier. The evaluation value misfit identifier has two kinds; one is “X” that shows the item evaluation value in relationship with the evaluation target person identifier showing a person identical to the evaluation target person identifier exceeds the item evaluation value in relationship with the evaluation target person identifier showing a person different from the item evaluation target person identifier by not less than 10% of the ideal value as being the predetermined value, and the other is “Δ” that shows the item evaluation value in relationship with the evaluation target person identifier showing a person identical to the evaluation target person identifier is below the item evaluation value in relationship with the evaluation target person identifier showing a person different from the item evaluation target person identifier by not less than 10% of the ideal value as being the predetermined value.

The evaluation outputting means 315 visibly displays the item evaluation value and the ratio to ideal value memorized in the evaluation memorizing means 310 through the screen output unit 3e. In this embodiment, if there is the evaluation value misfit identifier, the evaluation value misfit identifier is also displayed visibly.

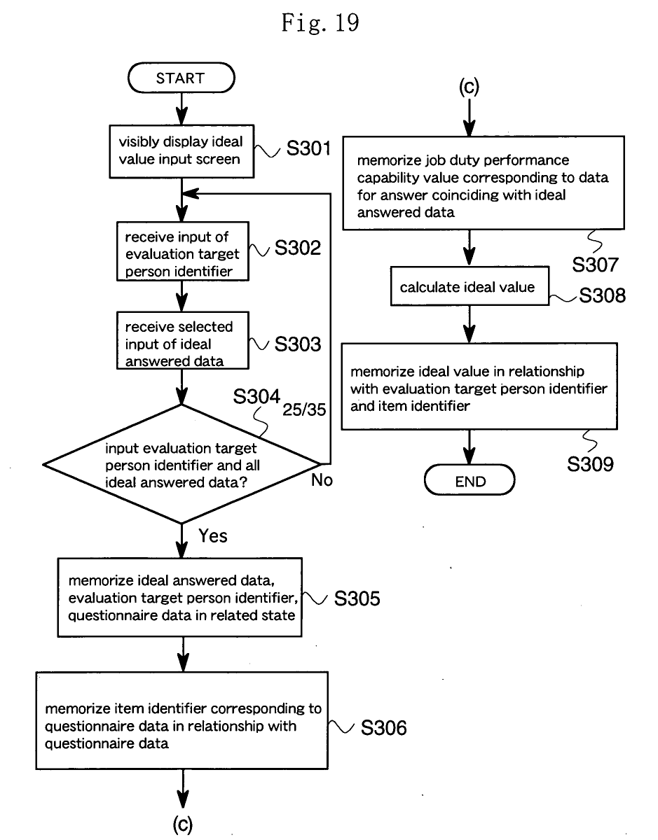

A flow of processes conducted by the information processing unit 3 in case of memorizing the ideal value for each evaluation target person will be shown. A flow chart of these processes is shown in FIG. 19.

First, display the ideal value corresponding job duty performance capability input screen to promote an input of the ideal answered data as being an answer to the questionnaire inquiring the job duty performance capability required for the evaluation target person (S301). Then receive an input of the evaluation target person identifier (S302), and successively receive an input of the ideal answered data (S303). Then judge whether or not the evaluation target person identifier, and all of the ideal answered data are input (S304), in case that the evaluation target person identifier, and all of the ideal answered data are not input, return to the step (S302) that receives the input of the evaluation target person identifier. In case that all of the ideal answered data are input, memorize the ideal answered data, the evaluation target person identifier, and the questionnaire data in a related state in the ideal answered data memorizing means 311d (S305). Next, memorize the item identifier corresponding to the questionnaire data memorized in the ideal answered data memorizing means 311d in relationship with the questionnaire data in the ideal answered data memorizing means 311d (S306). Furthermore, memorize the job duty performance capability value corresponding to the ideal answered data memorized in the ideal answered data memorizing means 311d in relationship with the ideal answered data in the ideal answered data memorizing means 311d (S307). Then obtain the ideal value by summing up the job duty performance capability values memorized in relationship with an identical evaluation target person identifier and an identical item identifier (S308), and memorize the obtained ideal value in relationship with the evaluation target person identifier, and the item identifier in the ideal value memorizing means 312 (S309).

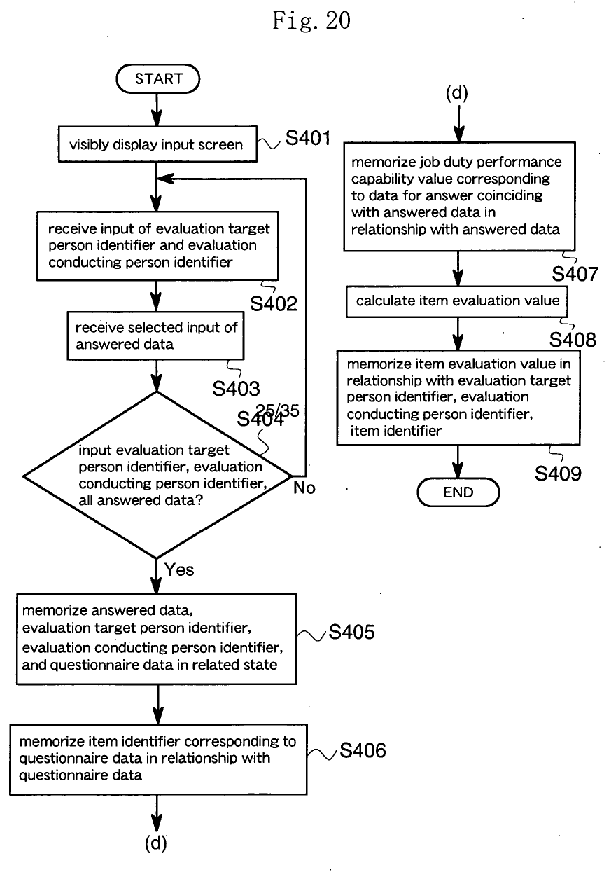

In case of judging skill of an employee as being an evaluation target person by the use of the personnel evaluation system S2, first an answer to the questionnaire is input by the evaluation target person and the item evaluation value is calculated based on the answer. A flow of processes conducted by the information processing unit 3 will be shown as follows. A flow chart of these processes is shown in FIG. 20.

First, display the job duty performance capability input screen to promote an input of the job duty performance capability (S401). Then receive an input of the evaluation target person identifier and the evaluation conducting person identifier (S402), and successively receive an input of the answered data (S403). Then judge whether or not the evaluation target person identifier, the evaluation conducting person identifier, and all of the answered data are input (S404), in case that the evaluation target person identifier, the evaluation conducting person identifier, and all of the job duty performance capability data are not input, output an error message to promote an input of all of the job duty performance capability data (S405), and return to the step (S403) that receives an input of the evaluation target person identifier and the evaluation conducting person identifier. In case that the evaluation target person identifier, the evaluation conducting person identifier, and all of the answered data are input, memorize the answered data, the evaluation target person identifier, the evaluation conducting person identifier and the questionnaire data in a related state in the answered data memorizing means 304 (S406). Next, memorize the item identifier corresponding to questionnaire data memorized in the answered data memorizing means 304 in the step S406 in relationship with the questionnaire data in the answered data memorizing means 304 (S407). Furthermore, memorize the job duty performance capability value corresponding to the answered data memorized in the answered data memorizing means 304 in the step S406 in relationship with the answered data in the answered data memorizing means 304 (S408). Then obtain the item evaluation value by summing up the job duty performance capability values memorized in the answered data memorizing means 304 in relationship with an identical evaluation target person identifier and an identical item identifier (S409), and memorize the obtained item evaluation value in relationship with the evaluation target person identifier, the evaluation conducting person identifier, and the item identifier in the memorizing means 310 (S410).

Next, a person other than the evaluation target person, for example, the evaluation target person's immediate supervisor inputs answers to the above-mentioned questionnaires and the item evaluation value is calculated based on the answers. Processes conducted by the information processing unit 3 are the same as those of the above-mentioned step S401 through S410.

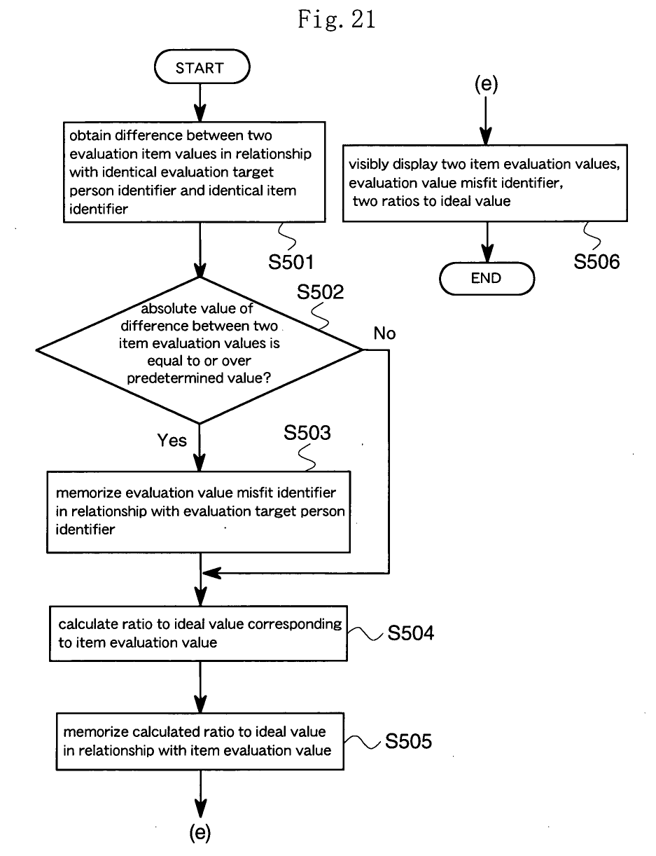

Obtain a material to verify propriety of the evaluation by comparison between the item evaluation value based on an answer to the questionnaire by the evaluation target person and the item evaluation value based on an answer to the questionnaire by a person other than the evaluation target person, for example, the evaluation target person's immediate supervisor. A flow of processes conducted by the information processing unit 3 will be shown as follows. A flow chart of these processes is shown in FIG. 21.

First, obtain a difference between the item evaluation value corresponding to the evaluation target person identifier showing that the evaluation is made by the evaluation target person and the item evaluation value corresponding to the evaluation conducting person identifier showing that the evaluation is made by a person other than the evaluation target person (S501). Next, judge whether or not an absolute value of the difference between the two item evaluation values equals to or over a predetermined value (S502). In case that the absolute value of the difference between the two item evaluation values equals to or over the predetermined value, memorize the evaluation value misfit identifier showing this state in relationship with the evaluation target person identifier showing the evaluation target person in the evaluation memorizing means 310 (S503). In case that the absolute value of the difference between the two item evaluation values is less than the predetermined value, proceed to the next step. Then calculate a ratio to the ideal value of each of the two item evaluation values respectively (S504), and memorize the calculated ratios to the ideal value in relationship with the item evaluation value in the evaluation memorizing means 310 (S505). Then visually output the two item evaluation values, the item evaluation value misfit identifier, and the two ratios to the ideal value to a screen respectively (S506).

As mentioned above, the personnel evaluation system S2 in accordance with this embodiment inputs the job duty performance capability for each job duty, digitalizes the input job duty performance capability and sums up the digitalized job duty performance capability for each item so as to calculate the item evaluation value. This makes it possible to judge the skill and merit and demerit of the evaluation target person, namely, of the employee necessary for each job duty of the evaluation target person. In addition, it is possible to evaluate and foster a person who is superior in the above-mentioned skill by referring to the item evaluation value and combining the item evaluation value with the wage evaluation.

In addition, since the inputs of the job duty performance capability by the evaluation target person and the person other than the evaluation target person are received respectively, the evaluation value as being a first evaluation value and the evaluation value as being a second evaluation value are calculated, the difference between the first item evaluation value and the second item evaluation value is calculated through the evaluation value checking means 312, and the evaluation value misfit identifier is associated with the evaluation target person identifier showing the evaluation target person in case that the absolute value of the calculated difference is equal to or over the predetermined value, it is possible to easily verify the propriety of the evaluation.

Furthermore, since a first ratio to the ideal value and a second ratio to the ideal value as being the ratio to the ideal value for the first item evaluation value and the second item evaluation value respectively are calculated respectively, it is possible to provide an established degree of the skill in compliance with the job functional rank or the like as the ratio to the ideal value if the ideal value is set for each evaluation target person and each job functional rank. More specifically, performance capability of the skill required for each job functional rank of each individual can be judged digitally.

In addition, since the ideal value is input for each evaluation target person through the ideal value input receiving means 311 and the ideal value is memorized through the ideal value memorizing means 312, it is possible to set the ideal value in compliance with the necessary skill for each evaluation target person.

Like the above-mentioned first embodiment, since the item includes the routine work, the personal administration, the marketing and sales project, and the job duty specific to an industry, it is possible to judge the skill and merit and demerit of the evaluation target person necessary for each job duty of the evaluation target person based on the item evaluation value for each item.

The present claimed invention is not limited to the above-mentioned embodiments.

For example, in the first and the second embodiments, the questionnaires inquiring stepwise evaluation of the performance capability of the job duty work in a pachinko industry are set and the skill is judged by digitalizing the answers to the questionnaires, however, this may be applied to other industry as far as questionnaires are set to inquire stepwise evaluation of the performance capability of the relevant industry.

In addition, in the first embodiment, it is also conceivable that, instead of the terminal unit 1, the information processing unit 2 may comprise the input screen displaying means 102 and the selected input receiving means 103 and the answered data memorizing means 204 may digitalize the answered data received by the selected input receiving means 103.

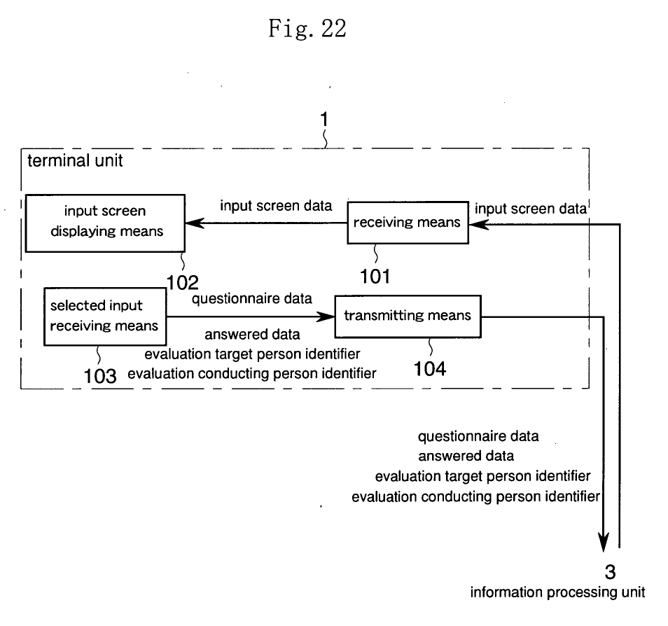

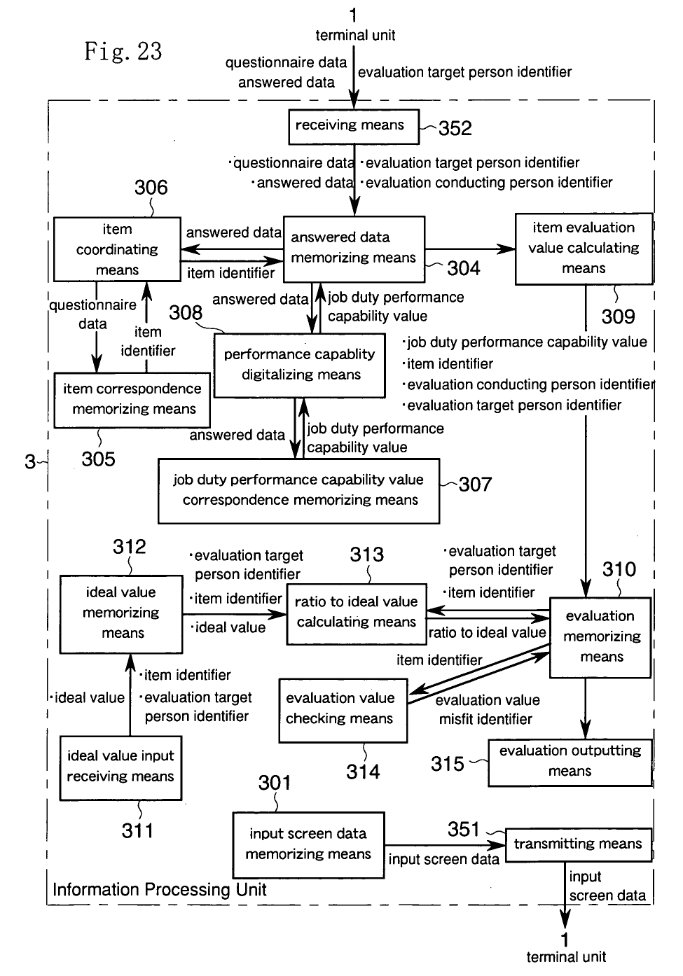

It is conceivable that in the above-mentioned second embodiment, the terminal unit 1 in the first embodiment is arranged in a working place of an employee as being the evaluation target person and the terminal unit 1 is connected with the information processing unit 3 through a communication line. An example of this state will be described as follows. In this state, the terminal unit 1 comprises, as shown in FIG. 22, the receiving means 101, the input screen displaying means 102, the selected input receiving means 103 and the transmitting means 104.

Like the first embodiment, the receiving means 101 receives the input screen data as being data to display an input screen to promote the applicant to input the answered data showing the answer to the questionnaire inquiring the performance capability of the job duty work from the information processing unit 3.

Like the first embodiment, the input screen displaying means 102 also receives the input screen data from the receiving means 101 and visibly displays the input screen data as shown in FIG. 5 by making use of the screen displaying means 1e.

The selected input receiving means 103 and the transmitting means 104 also have the same arrangement and functions as those of the first embodiment. In this state, the selected input receiving means 103 receives also the input of the evaluation conducting person identifier and the transmitting means 104 transmits also the evaluation conducting person identifier received by the selected input receiving means 103.

The information processing unit 3 further comprises a transmitting means 351 and a receiving means 352, wherein the input screen displaying means 302 and the selected input receiving means 303 are omitted.

The transmitting means 351 of the information processing unit 3 transmits the input screen data memorized in the input screen data memorizing means 301 to the terminal unit 1.

The receiving means 352 of the information processing unit 3 receives the answered data, the evaluation target person identifier, the evaluation conducting person identifier and the questionnaire data transmitted from the terminal unit 1 and passes them to the answered data memorizing means 304.

In accordance with this arrangement, administration of the item evaluation value can be consolidated by the information processing unit 3 in a case that a working place of an employee as being the evaluation target person is separated from a place where the information processing unit 3 is arranged such as a working place of a person who conducts the personnel evaluation.

In the above-mentioned second embodiment, the ideal value for each evaluation target person is input through the ideal value input receiving means 311 and memorized in the ideal value memorizing means 312, however, the attribute identifier showing an attribute such as a job functional rank of the evaluation target person may be coordinated with the evaluation target person identifier and the ideal value may be set for each evaluation target person and memorized in the ideal value memorizing means 312 as follows.

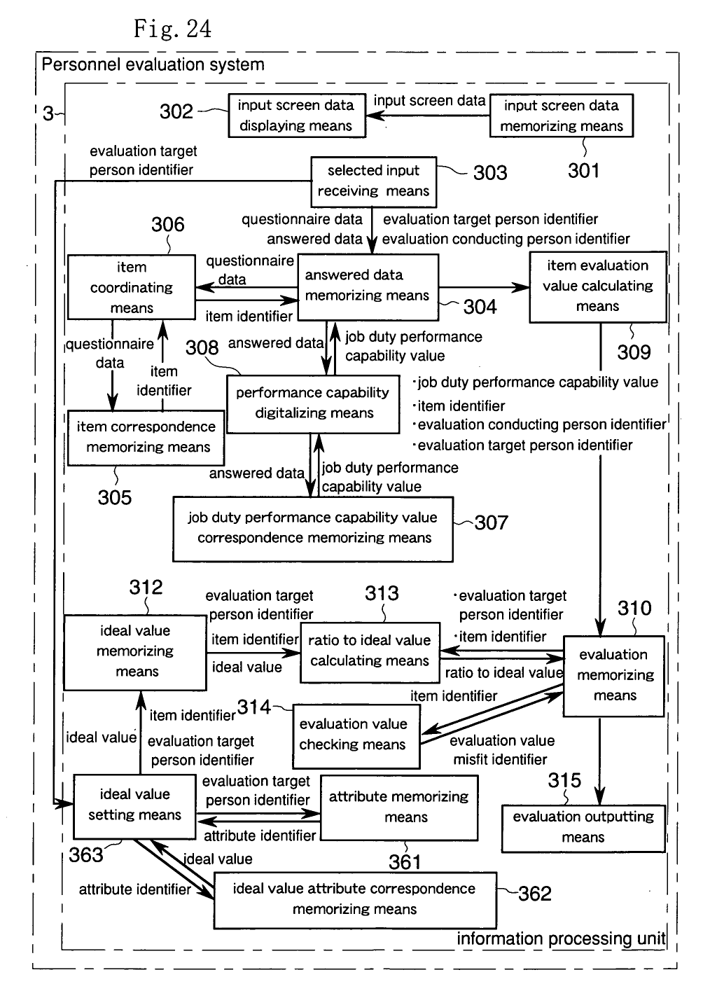

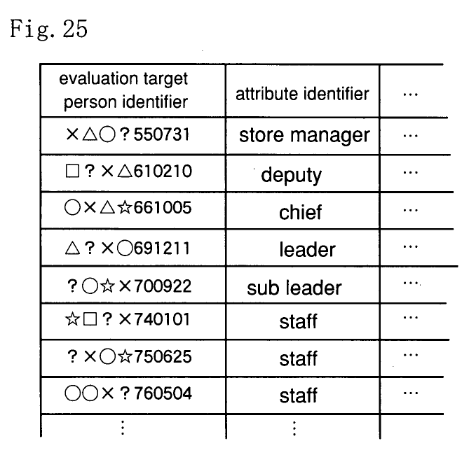

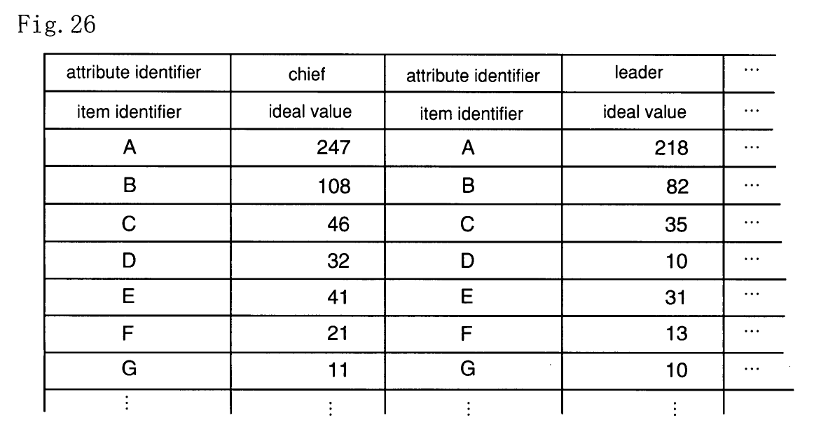

An example of this state will be explained by reference to FIG. 24 as being a functional block diagram. In this state, instead of the ideal value input receiving means 311, the personnel evaluation system further comprises an attribute memorizing means 361 that memorizes the attribute identifier and the evaluation target person identifier in a related state as shown in FIG. 25, an ideal value attribute correspondence memorizing means 362 that memorizes the ideal value in relationship with the attribute identifier as shown in FIG. 26, and the ideal value setting means 363 that receives the evaluation target person identifier from the selected input receiving means 303 and memorizes the attribute identifier coordinated with the evaluation target person identifier, the evaluation target person identifier and the ideal value coordinated with the attribute identifier in a related state based on a memorized content of the attribute memorizing means 361 and the ideal value attribute correspondence memorizing means 362.

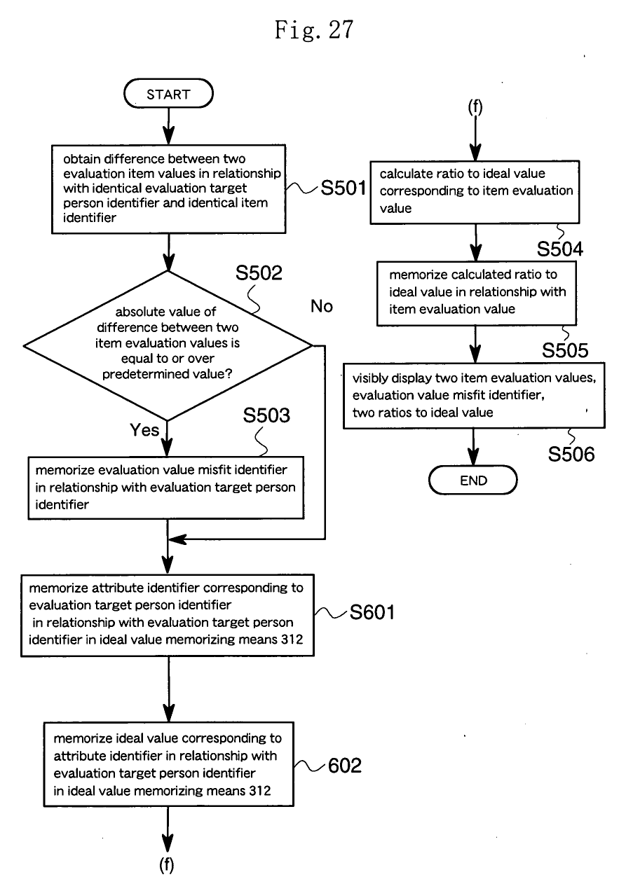

In this state, the steps S301 through S309 in the above-mentioned second embodiment are omitted and processes of setting the ideal value and calculating the ratio to the ideal value are conducted after the steps S501 through S503 in the second embodiment. A flow chart of these processes conducted by the information processing unit 3 after the item evaluation value is memorized in the memorizing means 310 will be described by reference to FIG. 27 as being a flow chart.

First, as mentioned above, conduct the steps S501 through S503 in the second embodiment. Next, the ideal value setting means 363 memorizes the attribute identifier coordinated with the evaluation target person identifier received from the selected input receiving means 303 in relationship with the evaluation target person identifier in the ideal value memorizing means 312 based on the memorized content in the attribute memorizing means 361 (S601). Then the ideal value coordinated with the evaluation target person identifier through the attribute identifier is memorized in the ideal value memorizing means 312 based on the memorized content in the ideal value attribute correspondence memorizing means 362 (S602). After this step, the steps S504 through S506 in the second embodiment are conducted.

In accordance with this arrangement, since the ideal value is set not for each evaluation target person but based on the attribute of the job functional rank of the evaluation target person, it is possible to simplify an operation of inputting the ideal value.

Furthermore, in the above-mentioned state, a mean ratio to ideal value for each attribute calculating means that calculates a mean value of the ratio to the ideal value coordinated with an identical attribute identifier and an identical item identifier may be further arranged. In accordance with this arrangement, it is possible to calculate the mean value of the ratio to the ideal value of a person belonging to a relevant job functional rank for each job functional rank, thereby enabling to evaluate an established degree of the skill for every person belonging to each job functional rank in a company.

In addition, the evaluation target person identifier may be coordinated with a second attribute identifier that shows a working place such as a branch office, a sales office, and an outlet or a belonging department, and a mean ratio to ideal value for each second attribute calculating means that calculates a mean value of the ratio to the ideal value coordinated with an identical second attribute identifier and an identical item identifier may be further arranged. In accordance with this arrangement, it is possible to calculate the mean value of the ratio to ideal value of a person belonging to a relevant working place for each working place, thereby enabling to evaluate an established degree of the skill for every person belonging to each working place or belonging department in a company.

Furthermore, multiple item evaluation values coordinated with an identical evaluation target person identifier, an identical item identifier, and an identical evaluation conducting person identifier and calculated on a different day may be memorized in the evaluation memorizing means. In accordance with this arrangement, it is possible to verify a growing degree of the performance capability of a job duty work of an identical person.

In addition, the job duty-performance capability may be set as not four steps as described in the above-mentioned first and the second embodiments but as two steps; for example, “+” showing that the evaluation target person can carry out the job duty work completely and can educate others about the work, and “−” showing that the evaluation target person does not satisfy a condition of “+”.

In case that an industry consists of multiple job descriptions, an item may be set for each job description for a job duty specific to the industry and a different item identifier may be applied to each item respectively. For example, in case of a food service industry, an item showing a job duty regarding cooking and an item showing a job duty regarding floor service such as a waiter may be set respectively and an item identifier “D1” may be given to the former item, and an item identifier “D2” may be given to the later item.

In addition, questionnaires to judge an ability generally called as “sociality in a working place” such as a communication capability, an interpersonal skill, a leadership ability, a expressive power, a positive attitude, cooperativeness, endurance, comprehensive faculty, a sense of responsibility or the like, may be prepared, and questionnaire data of the questionnaires may be coordinated with an item identifier, for example, “X”, showing that the questionnaire judges “the sociality in a working place”, and an item evaluation value showing “the sociality in a working place” may be obtained from an answered data coordinated with the item identifier “X” by the same procedure as that of the other item evaluation value by the item evaluation value calculating means 209. In this case, a verifying means that verifies authenticity of the answered data to the questionnaires to judge the ability by comparing a correlation between the job duty performance capabilities obtained by digitalizing the answered data with an experimentally obtained general tendency may be further provided for the ability generally called as “sociality in a working place”.

Furthermore, for the job duty performance capability a relevant answer data is selected among the visibly displayed questionnaire items and input through a keyboard, a mouse or a touch panel or the like, however, it may be filled out on a mark sheet by an evaluation target person and the filled out answer data may be read and input through a mark card reader, or it may be handwritten by the evaluation target person and the handwritten answer data may be read and input through a scanner or the like.

As a terminal unit, a cellular phone may be used, in stead of the personal computer. In this case, a program to operate the cellular phone as the terminal unit is memorized in an internal memory and the cellular phone is connected with a communication line through a wireless module instead of the input/output interface for the personal computer.

Especially, in the first embodiment, accounting target information represented by a telephone number of a cellular phone or a number of a credit card, as being information to conduct accounting, may be transmitted to the information processing unit in a state coordinated with the evaluation target person identifier in addition to the evaluation target person identifier, and may be memorized in the evaluation memorizing means in a state coordinated with the accounting target information and the evaluation target person identifier. In accordance with this arrangement, the accounting target information memorized in the memorizing means can be notified to a cellular phone company or a credit card company so as to charge through the cellular phone company or the credit card company.

In addition, the evaluation value for each item is not only displayed visibly by the use of the screen display unit but also output to print out to paper or the like through a printer.

Furthermore, a total evaluation value as being a value summing up all of numerical values of the digitalized job duty performance capability may be calculated. An ideal value corresponding to the total evaluation value may be set for each evaluation target person and a ratio of the total evaluation value to the ideal value may be calculated and memorized. In addition, the total evaluation value is not obtained as a simple sum total of the numerical values of all of the job duty performance capability but may be obtained as a weighted average of the evaluation value for each item based on, for example, an item evaluation gravity previously set for each item.

Especially in the first embodiment, it may be conceived that data concerning a questionnaire inquiring a background of the evaluation target person is included in the input screen data that the receiving means 101 receives from the information processing unit 2, the input screen displaying means 102 also displays data for answer showing stepwise evaluation that the evaluation target person digitalizes a relevant item to the questionnaire inquiring the background of the evaluation target person, and the selected input receiving means 103 also receives answered data to the questionnaire concerning the background of the evaluation target person and transmits it to the transmitting means 104. In this state, in a side of the information processing unit 2, if the item correspondence memorizing means 205 memorizes the questionnaire data concerning the questionnaires inquiring the background of the evaluation target person in relationship with an item identifier “Z” showing that the questionnaires inquire the background of the evaluation target person, the job duty performance capability value correspondence memorizing means memorizes background data as being the data for answer showing stepwise evaluation that the evaluation target person digitalizes the relevant item to the questionnaire inquiring the background of the evaluation target person, and the item evaluation value calculating means 209 additionally calculates a background evaluation value from the background data coordinated with the item identifier “Z” by the same process as that of the other item evaluation value, it is possible to refer the background of the evaluation target person in case of mid-career recruitment.

In addition, in case that the same information processing unit is shared by multiple companies, it can be conceived that the information processing unit comprises an item evaluation gravity receiving means that receives an input and reception of a company identifier showing a company or the like and item evaluation gravity set for each company and each item, an evaluation gravity by company memorizing means that memorizes the company identifier and the item evaluation gravity in a related state, and a total evaluation value for each company calculating means that calculates a total evaluation value for each company by summing up a weighted item evaluation value for each company as being an integrated value of the item evaluation value calculated by the item evaluation value calculating means and the item evaluation gravity set for each company, and the company identifier and the evaluation target person identifier are memorized in a related state in the evaluation memorizing means. Furthermore, it may be conceived that the terminal unit comprises a company identifier receiving means that receives an input of a company identifier and the information processing unit comprises an evaluation value transmitting means that transmits the total evaluation value for each company coordinated with the company identifier to the terminal unit. A concept of “a company or the like” is not limited to profit-making corporations but includes, for example, nonprofit-making corporations, government and other public offices, and other various lobbies conducting recruiting or evaluation.

An example of a concrete arrangement of the above-mentioned state will be described.

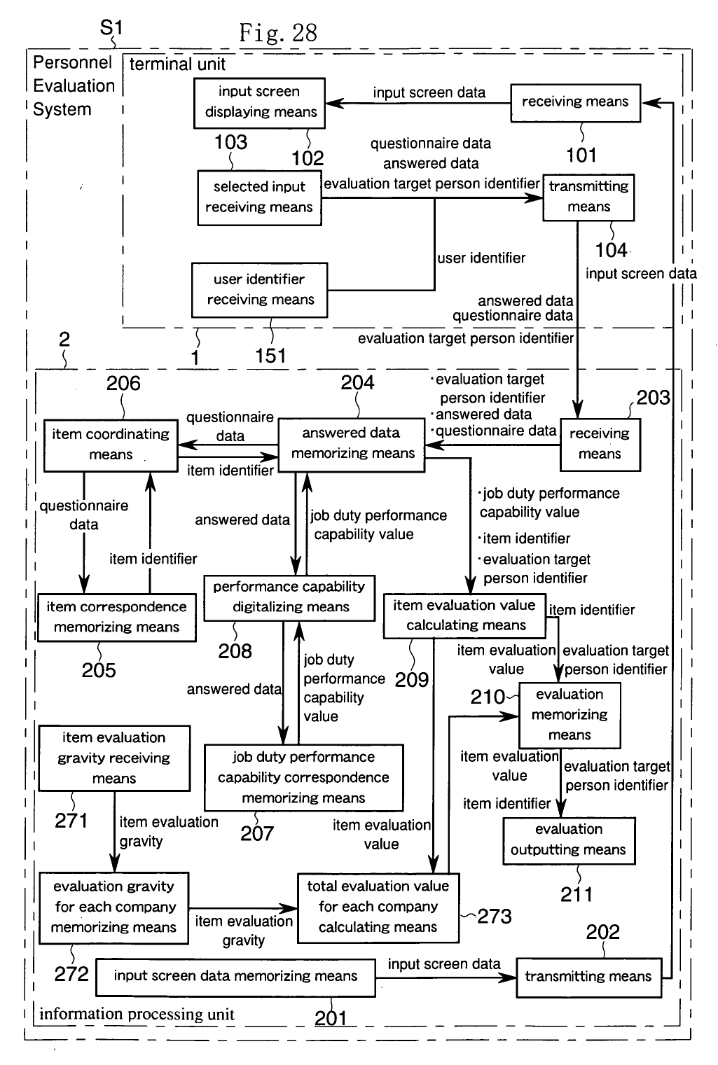

The terminal unit 1 has generally the same arrangement as that of the first embodiment. The program memorized in the external memory unit 1c is executed by the CPU 1a. The terminal unit 1 functions, as shown in FIG. 28, the receiving means 101, the input screen displaying means 102, the selected input receiving means 103, the transmitting means 104, and a company identifier receiving means 171. The input unit 1g may be a keyboard, a mouse, or a touch panel. The terminal unit 1 may make use of a cellular phone. In this case, the program to make the terminal unit 1 function as the receiving means 101, the input screen displaying means 102, the selected input receiving means 103, the transmitting means 104, and a company identifier receiving means 171 is received from the information processing unit 2, memorized in the internal memory 1b or the external memory unit 1c of the terminal unit 1, and executed by the CPU 1a of the terminal unit 1.

The information processing unit 2 is arranged at a side of a company and has generally the same arrangement as that of the above-mentioned first embodiment. The program memorized in the external memory unit 2c is executed by the CPU 2a. The information processing unit 2 functions, as shown in FIG. 28, the input screen data memorizing means 201, the transmitting means 202, the receiving means 203, the answered data memorizing means 204, the item correspondence memorizing means 205, the item coordinating means 206, the job duty performance capability value correspondence memorizing means 207, the performance capability digitalizing means 208, the item evaluation value calculating means 209, the evaluation memorizing means 210, the evaluation outputting means 211, an item evaluation gravity receiving means 271, an evaluation gravity by company memorizing means 272, and a total evaluation value for each company calculating means 273.

Each of the receiving means 101, the input screen displaying means 102, the selected input receiving means 103, the transmitting means 104, the input screen data memorizing means 201, the transmitting means 202, the receiving means 203, the answered data memorizing means 204, the item correspondence memorizing means 205, the item coordinating means 206, the job duty performance capability value correspondence memorizing means 207, the performance capability digitalizing means 208, the item evaluation value calculating means 209, the evaluation memorizing means 210, and the evaluation outputting means 211 has generally the same arrangement as that of the above-mentioned first embodiment.

The company identifier receiving means 171 receives the input of the company identifier showing a company or the like that the applicant desires by making use of the input unit 1g.

The item evaluation gravity receiving means 271 receives the company identifier and the item evaluation gravity by making use of the input unit 2g or the input/output interface 2d.

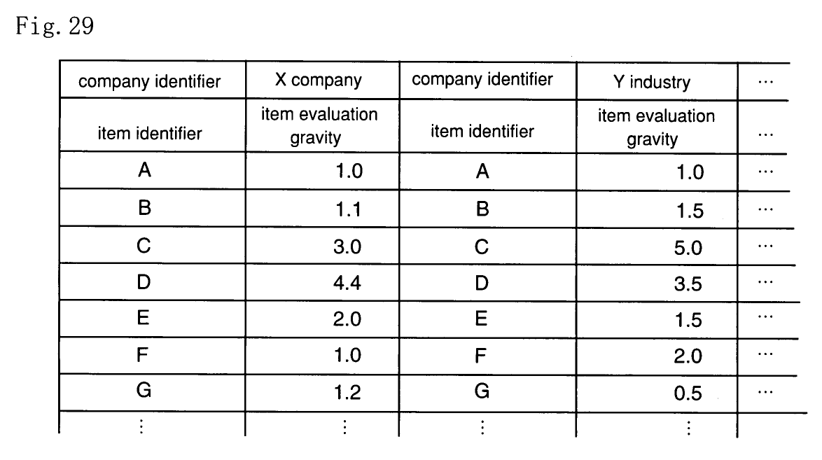

The evaluation gravity by company memorizing means 272 memorizes the company identifier and the item evaluation gravity received by the item evaluation gravity receiving means 271 in a related state in a predetermined area of the external memory unit 2c, as shown in FIG. 29.

The total evaluation value by company calculating means 273 calculates the total evaluation value for each company by summing up the weighted item evaluation values for each company as being an integrated value of the item evaluation value calculated by the item evaluation value calculating means 209 and the item evaluation gravity set for each company.

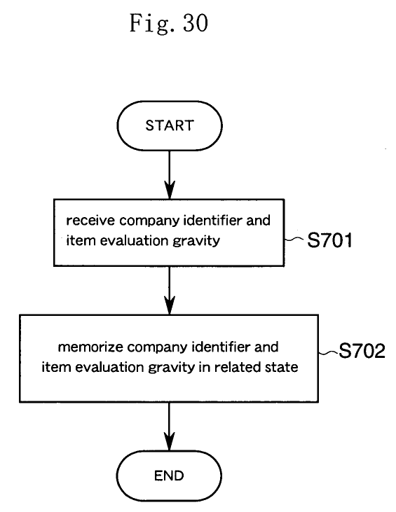

The information processing unit 2 conducts the following processes whose flow chart is shown in FIG. 30 in order to register the item evaluation gravity for each company. First, the item evaluation gravity receiving means 271 receives the company identifier and the item evaluation gravity (S701). Next, the evaluation gravity by company memorizing means 272 memorizes the company identifier and the item evaluation gravity in a related state (S702).

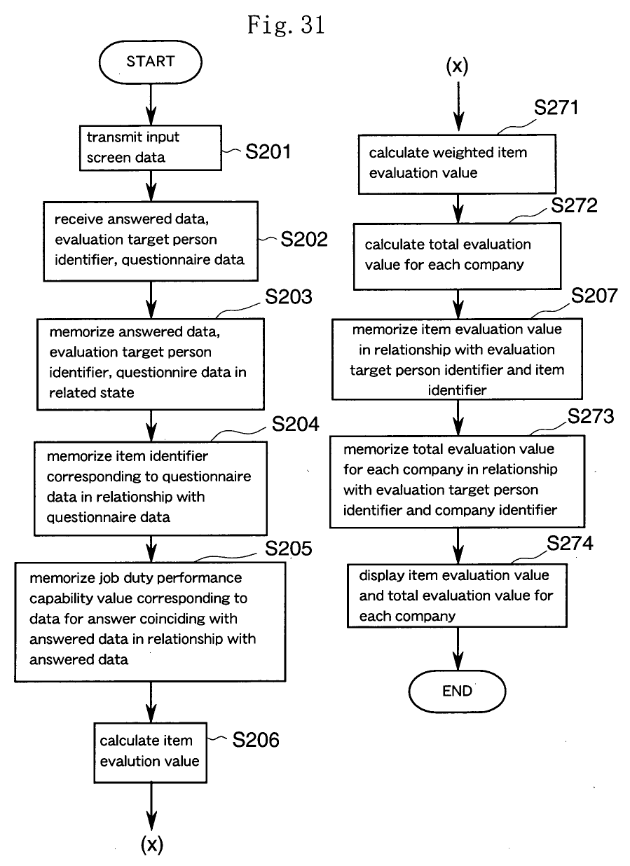

Then the information processing unit 2 conducts the following processes whose flow chart is shown in FIG. 31, in case of calculating the total evaluation value for each company in accordance with an evaluation standard of the company. First, conduct processes of the steps S201 through S206 of the first embodiment. Next, the total evaluation value for each company calculating means 273 calculates the weighted item evaluation value by integrating the item evaluation value and the item evaluation gravity (S271), and the total evaluation value for each company is calculated by summing up the calculated weighted item evaluation values for each company (S272). Next, the obtained item evaluation value is memorized in relationship with the evaluation target person identifier and the item identifier in the evaluation memorizing means 210 (S207), and the total evaluation value for each company is memorized in relationship with the evaluation target person identifier and the company identifier in the evaluation memorizing means 210 (S273). Then the item evaluation value memorized in the step S207 and the total evaluation value for each company memorized in the step S273 are visualized and output to a screen (S274).

In accordance with this arrangement, it is possible to set heavy item evaluation gravity on an item on which a company puts a high value for each company, thereby enabling to easily extract an applicant having skill and career on which the company puts a high value by making use of the total evaluation value for each company, enabling to refer evaluation of an employee in whole of the industry and evaluation based on a standard inherent to the company if multiple companies of an identical industry make use of an identical information processing unit. In addition, if the total evaluation value for each company corresponding to the company identifier received by the company identifier receiving means is transmitted from the information processing unit to the terminal unit through the evaluation value transmitting means, it is possible to actualize a state wherein an applicant inputs a company identifier corresponding to a company that the applicant desires to apply and evaluation on the applicant by the company that the applicant desires to apply is notified by the terminal unit. Furthermore, if the item evaluation gravity to obtain standard evaluation in whole of an industry is additionally set, the company identifier showing whole of the industry is memorized in relationship with the item evaluation gravity in the evaluation gravity by company memorizing means 272 and the total evaluation value for each company is calculated by making use of the item evaluation gravity, it is possible to know the standard evaluation in whole of the industry to which the company belongs. A method for setting the item evaluation gravity to obtain the standard evaluation in whole of the industry may be to allot “1” to all of the items.

In order to make it possible to easily extract an applicant having skill and career on which the company put an high value by making use of the total evaluation value for each company, it can be conceived that the ideal value in the second embodiment is set for each company and the ratio to ideal value is calculated for each company like the second embodiment, in addition to the method that uses the item evaluation gravity. It is a matter of course that item evaluation gravity and the ideal value may be set for each job description or each job functional rank in an identical company.

Furthermore, in the first embodiment, it can be conceived that the terminal unit further comprises a person specifying information receiving means that receives an input of person specifying information as being information to specify the applicant by making use of inherent data and a person specifying auxiliary information receiving means that receives an input of person specifying auxiliary information as being information formed by enciphering the person specifying information, and the transmitting means transmits the person specifying information and the person specifying auxiliary information together with the answered data, and the information processing unit further comprises a person specifying information reception judging means that judges whether the person specifying information and the person specifying auxiliary information are received or not, and a certifying means that discontinues a subsequent process in case that both of the person specifying information and the person specifying auxiliary information are not received or either one of them is not received. The inherent data used for the person specifying information may be, for example, image data of a fingerprint of a right index finger of the applicant, a password that is unknowable to others except for the applicant, a social security number in the United States, or a combination of them. The person specifying auxiliary information may be, for example, a two dimensional bar code made based on the person specifying information. In addition, it can be conceived that the information processing unit comprises an answered data tentative memorizing means that memorizes the answered data in case that the receiving means receives data including either one of the person specifying information and the person specifying auxiliary information, a person specifying urging means that transmits a message to urge the evaluation target person to immediately transmit the person specifying information and the person specifying auxiliary information, a person specifying information receiving means that receives the person specifying information and the person specifying auxiliary information, and an answered data transferring means that searches the answered data that includes either one of the person specifying information and the person specifying auxiliary information received by the person specifying information receiving means from the answered data tentative memorizing means and transfers it to the answered data memorizing means.

An example of a concrete arrangement of the above-mentioned state will be described.

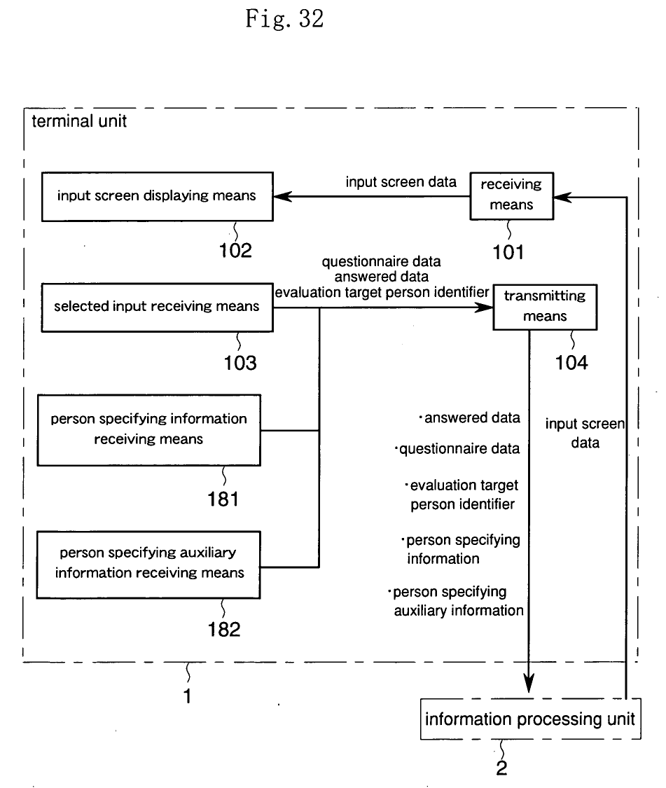

The terminal unit 1 has generally the same arrangement as that of the first embodiment. The program memorized in the external memory unit 1c is executed by the CPU 1a. The terminal unit 1 functions as, as shown in FIG. 32, the receiving means 101, the input screen displaying means 102, the selected input receiving means 103, the transmitting means 104, a person specifying information receiving means 181, and a person specifying auxiliary information receiving means 182. The input unit 1g may be a keyboard, a mouse, or a touch panel. The terminal unit 1 may make use of a cellular phone. In this case, the program to make the terminal unit 1 function as the receiving means 101, the input screen displaying means 102, the selected input receiving means 103, the transmitting means 104, the person specifying information receiving means 181, and the person specifying auxiliary information receiving means 182 is received from the information processing unit 2, memorized in a memory unit of the terminal unit 1, and executed by the CPU 1a of the terminal unit 1.

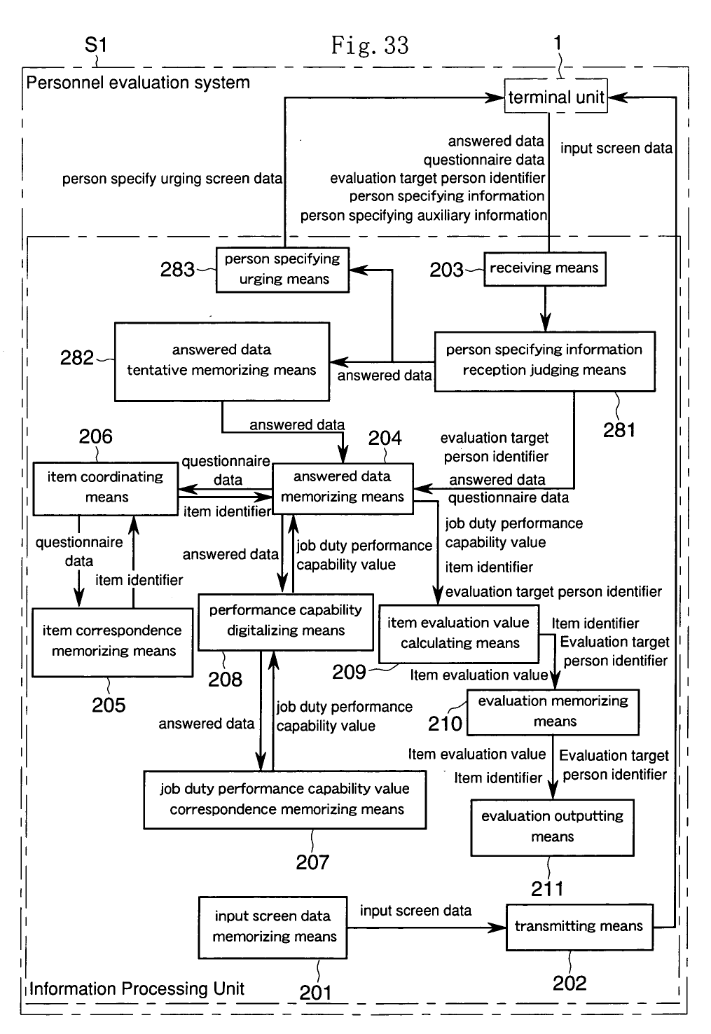

The information processing unit 2 is arranged at a side of a company and has generally the same arrangement as that of the first embodiment. The program memorized in the external memory unit 2c is executed by the CPU 2a. The information processing unit 2 functions as, as shown in FIG. 33, the input screen data memorizing means 201, the transmitting means 202, the receiving means 203, the answered data memorizing means 204, the item correspondence memorizing means 205, the item coordinating means 206, the job duty performance capability value correspondence memorizing means 207, the performance capability digitalizing means 208, the item evaluation value calculating means 209, the evaluation memorizing means 210, the evaluation outputting means 211, an person specifying information reception judging means 281, an answered data tentative memorizing means 282, a person specifying urging means 283, and a data checking means 284.

Each of the receiving means 101, the input screen displaying means 102, the selected input receiving means 103, the transmitting means 104, the input screen data memorizing means 201, the transmitting means 202, the receiving means 203, the answered data memorizing means 204, the item correspondence memorizing means 205, the item coordinating means 206, the job duty performance capability value correspondence memorizing means 207, the performance capability digitalizing means 208, the item evaluation value calculating means 209, the evaluation memorizing means 210, and the evaluation outputting means 211 has generally the same arrangement as that of the first embodiment.

The person specifying information receiving means 181 receives an input of person specifying information by making use of the input unit 1g in case of inputting the answered data and in case of receiving a person specify urging message from the information processing unit 2.

The person specifying auxiliary information receiving means 182 receives an input of person specifying auxiliary information by making use of the input unit 1g in case of inputting the answered data and in case of receiving a person specify urging message from the information processing unit 2. The input unit 1g that the person specifying auxiliary information receiving means 182 makes use of may be a CCD camera or an image scanner or the like.

The person specifying information reception judging means 281 makes a judgment whether or not the person specifying information and the person specifying auxiliary information are included in data received by the receiving means 203 and conducts a process to terminate a subsequent process in case a result of the judgment is “no”.

The answered data tentative memorizing means 282 makes a judgment whether or not either one of the person specifying information and the person specifying auxiliary information is included in the data received by the receiving means 203 and memorizes the answered data in relationship with the received person specifying information or the received person specifying auxiliary information in a predetermined area of the external memory unit 3c in case a result of the judgment is “yes”.

The person specifying urging means 283 transmits the person specify urging message as being a message to urge the evaluation target person to immediately transmit the person specifying information and the person specifying auxiliary information memorized in the predetermined area of the external unit 3c to the terminal unit 1 through the input/output interface 2d.

The data checking means 284 searches the answered data that includes either one of the person specifying information and the person specifying auxiliary information received by the receiving means 203 from the answered data tentative memorizing means 282 and transfers it to the answered data memorizing means 204.

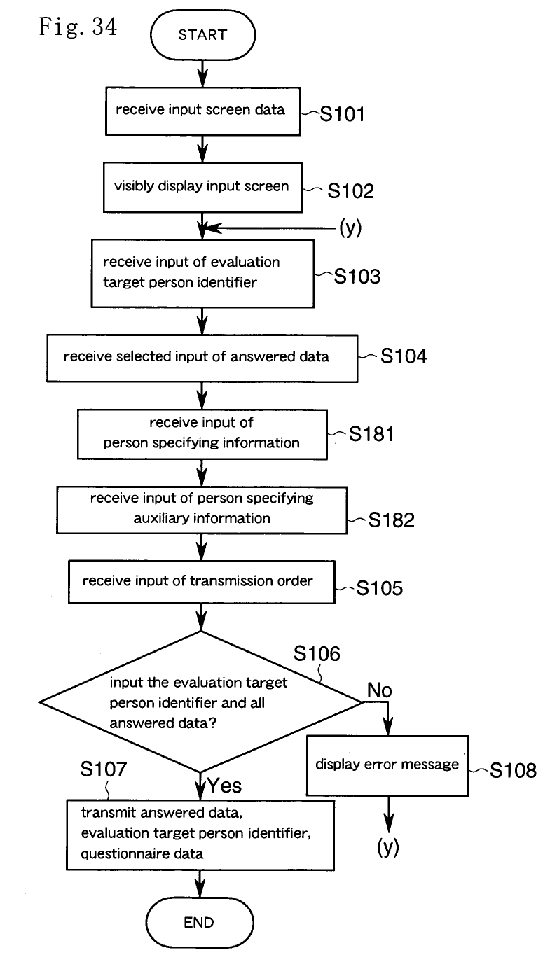

In this state, the terminal unit 1 conducts processes whose flow chart is shown in FIG. 34. More specifically, the terminal unit 1 conducts the processes of the steps S101 through S104 in the first embodiment, and then the step to receive the person specifying information (S181) and the step to receive the person specifying auxiliary information (S182), followed by the processes of the steps S105 through S108 in the first embodiment.

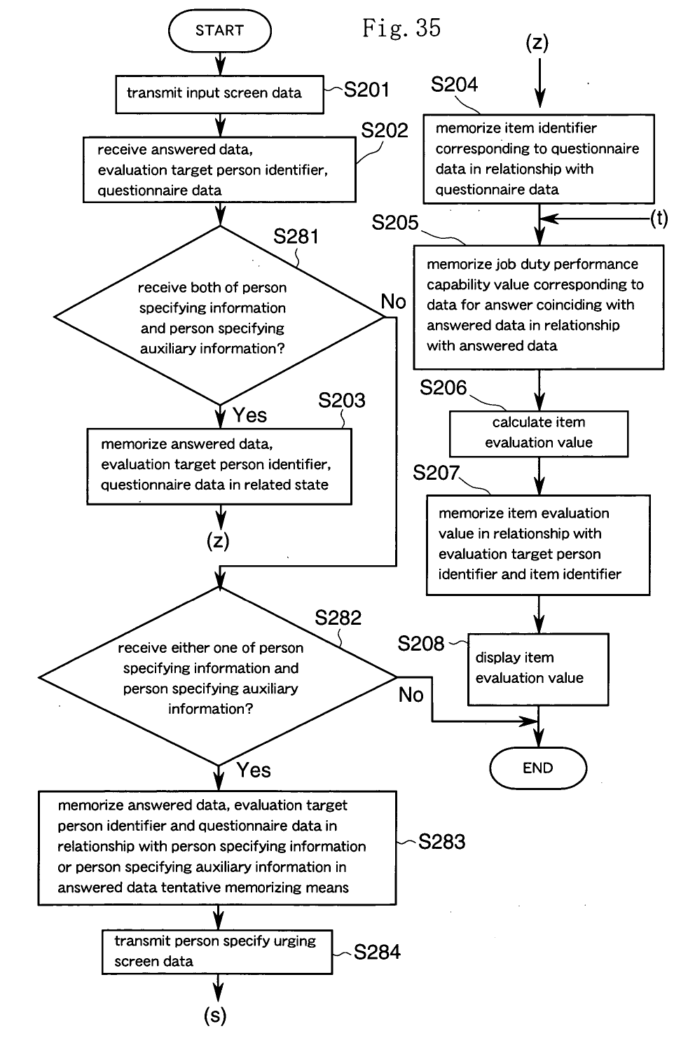

The information processing unit 2 conducts processes whose flow chart is shown in FIG. 35. More specifically, the information processing unit 2 conducts the processes of the steps S201 through S202 in the first embodiment, and then makes a judgment whether or not the person specifying information and the person specifying auxiliary information are actually received (S281). In case that a result of the judgment is “yes”, the processes of the steps S203 through S208 in the first embodiment are conducted. In case that the result of the judgment is “no”, a judgment whether or not the receiving means receives only either one of the person specifying information and the person specifying auxiliary information is subsequently made (S282). In case that a result of the judgment is “yes”, the answered data, the evaluation target person identifier, and the questionnaire data are memorized in relationship with the received person specifying information or the received person specifying auxiliary information in the answered data tentative memorizing means 282 (S283) and person specify urging screen data is transmitted to the terminal unit 1 (S284). In case that the result of the judgment is also “no”, the process is discontinued immediately.

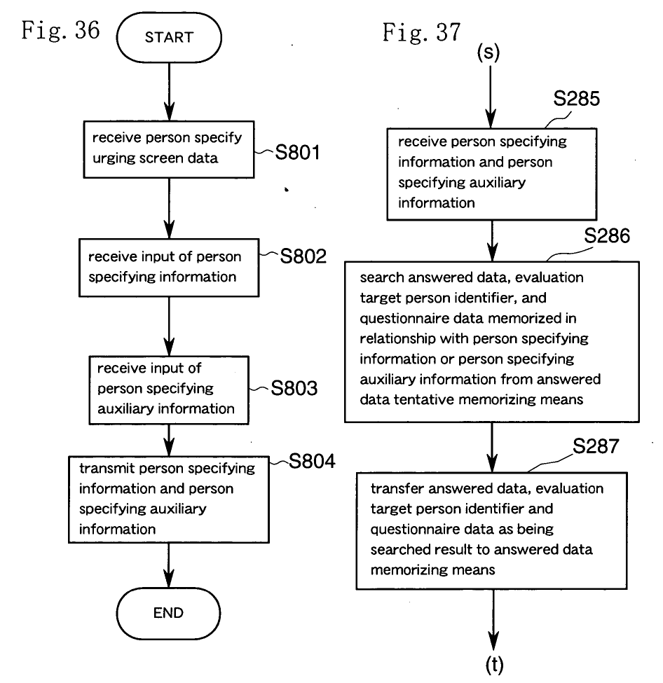

Then the terminal unit 1 anew conducts a step to receive the person specifying information (S801) and a step to receive the person specifying auxiliary information (S802) and then transmits the person specifying information and the person specifying auxiliary information to the information processing unit 2 (S803), wherein a flow chart of these processes is shown in FIG. 36.

The information processing unit 2 receives the person specifying information and the person specifying auxiliary information (S285), searches the answered data, the evaluation target person identifier, and the questionnaire data memorized in relationship with the received person specifying information or the received person specifying auxiliary information in the answered data tentative memorizing means 282 (S286), conducts a process to transfer them to the answered data memorizing means 204 (S287) and conducts processes of the steps S205 through S208 successively, wherein a flow chart of these processes is shown in FIG. 37.

In accordance with this arrangement, especially in a state, wherein the information processing unit is connected with a public circuit such as the Internet and the information processing unit is commonly used by multiple companies with charging use fee, it is possible to provide the companies with more useful data with eliminating a possible “mockery” applicant pretending to be other person or a fictional person. In addition, in case that the evaluation target person can transmit either one of the person specifying information and the person specifying auxiliary information for a certain reason, it is possible to memorize the answered data in the answered data tentative memorizing means and to ask the evaluation target person to transmit anew the person specifying information and the person specifying auxiliary information, thereby enabling to enhance convenience for the applicant.

In this state, the above-mentioned weighted item evaluation value or the ratio to the ideal value may be further calculated.

There may be various modifications without departing from the spirit of the invention.

1. A personnel evaluation method, executing a step that classifies a job duty of an evaluation target person into multiple items in order to show skill of each item in a digitalized manner based on answered data that shows an answer to a questionnaire inquiring a performance capability of a job duty work belonging to each item and that receives an answer selected from data for answer that shows stepwise evaluation of a performance capability as the answered data, a step that memorizes the answered data in relationship with an item identifier that shows an item to which a job duty work inquired by the questionnaire belongs and an evaluation target person identifier that shows the evaluation target person, a step that memorizes a job duty performance capability value corresponding to the data for answer that coincides with the answered data in relationship with the answered data based on a relationship between the previously memorized data for answer and a job duty performance capability value as being digitalized data for answer, and a step that obtains an item evaluation value showing skill of the relevant item by summing up the job duty performance capability values related with an identical item identifier and an identical evaluation target person identifier.

2. A personnel evaluation system, making use of a terminal unit having an input element to selectively input answered data showing an answer to a questionnaire inquiring a performance capability of a job duty work belonging to each item, wherein the job duty of an evaluation target person is classified into multiple items, and an information processing unit having a memory element, and comprising a selected input receiving means that receives a selected input of the answered data showing the answer to the questionnaire through the input element,
an answered data memorizing means that memorizes the answered data received by the selected input receiving means in relationship with an item identifier that shows an item to which the job duty work inquired by the questionnaire belongs and an evaluation target person identifier that shows an evaluation target person,
a job duty performance capability value correspondence memorizing means that memorizes the data for answer showing stepwise evaluation of the performance capability in relationship with a job duty performance capability value as being digitalized data for answer,
a job duty performance capability value digitalizing means that memorizes the job duty performance capability value corresponding to the data for answer that coincides with the answered data memorized in the answered data memorizing means in relationship with the answered data based on a memorized content of the job duty performance capability value correspondence memorizing means in the answered data memorizing means, an item evaluation value calculating means that obtains an item evaluation value by summing up the job duty performance capability values memorized in the answered data memorizing means in relationship with an identical evaluation target person identifier and an identical item identifier,
an evaluation memorizing means that memorizes the item evaluation value obtained by the item evaluation value calculating means in relationship with the evaluation target person identifier and the item identifier, and
an evaluation outputting means that outputs the item evaluation value memorized in the evaluation memorizing means.

3. The personnel evaluation system described in claim 2, wherein the item evaluation value calculating means obtains a routine work evaluation value that is obtained by summing up the job duty performance capability values in relationship with the item identifier showing that the questionnaire inquires the performance capability of the work concerning a routine work, as an item evaluation value.

4. The personnel evaluation system described in claim 2, wherein the item evaluation value calculating means obtains a personal management evaluation value that is obtained by summing up the job duty performance capability values in relationship with the item identifier showing that the questionnaire inquires the performance capability of the work concerning personal management, as an item evaluation value.

5. The personnel evaluation system described in claim 2, wherein the item evaluation value calculating means obtains a marketing and sales project evaluation value that is obtained by summing up the job duty performance capability values in relationship with the item identifier showing that the questionnaire inquires the performance capability of the work concerning a marketing and sales project, as an item evaluation value.

6. The personnel evaluation system described in claim 2, wherein the item evaluation value calculating means obtains an industry inherent job duty evaluation value that is obtained by summing up the job duty performance capability values in relationship with the item identifier showing that the questionnaire inquires the performance capability of the work concerning an industry inherent job duty, as an item evaluation value.

7. The personnel evaluation system described in claim 2, wherein the item evaluation value calculating means obtains paperwork evaluation value that is obtained by summing up the job duty performance capability values in relationship with the item identifier showing that the questionnaire inquires the performance capability of the work concerning paperwork, as an item evaluation value.

8. The personnel evaluation system described in claim 2, wherein the item evaluation value calculating means obtains a risk management evaluation value that is obtained by summing up the job duty performance capability values in relationship with the item identifier showing that the questionnaire inquires the performance capability of the work concerning risk management, as an item evaluation value.

9. The personnel evaluation system described in claim 2, and further comprising a ratio to ideal value calculating means that obtains a ratio of the item evaluation value to an ideal value coordinated with the evaluation target person identifier.

10. The personnel evaluation system described in claim 9, and further comprising an ideal value input receiving means that receives an input of the ideal value corresponding to each evaluation target person identifier.

11. The personnel evaluation system described in claim 9, used for a state to coordinate the evaluation target person identifier with an attribute identifier that shows an attribute of the evaluation target person, and further comprising an ideal value attribute correspondence memorizing means that memorizes the ideal value in relationship with the attribute identifier and an ideal value setting means that coordinates the ideal value, coordinated through the attribute identifier coordinated with the evaluation target person identifier, with the evaluation target person identifier.

12. The personnel evaluation system described in claim 11, and further comprising an average ratio to ideal value by attribute calculating means that calculates an average of the ratio to the ideal value memorized in relationship with an identical attribute identifier and an identical item identifier.

13. The personnel evaluation system described in claim 2, wherein the evaluation memorizing means memorizes an identical evaluation target person identifier and an identical item identifier in relationship with multiple item evaluation values.

14. The personnel evaluation system described in claim 13, and further comprising an evaluation value checking means that obtains a difference between two item evaluating values in relationship with the identical evaluation target person identifier and the identical item identifier.

15. The personnel evaluation system described in claim 2, and connecting the terminal unit with the information processing unit through a communication line,
wherein the terminal unit comprises the input element, the selected input receiving means, and the transmitting means that transmits the answered data received by the selected input receiving means, and
the information processing unit comprises the receiving means that receives the answered data, the answered data, memorizing means, the job duty performance capability value correspondence memorizing means, the performance capability digitalizing means, the item evaluation value calculating means, the evaluation memorizing means, and the evaluation outputting means.

16. The personnel evaluation system described in claim 15, wherein the terminal unit comprises a person specifying information receiving means that receives an input of person specifying information as being information to specify the applicant by making use of an inherent data and a person specifying auxiliary information receiving means that receives an input of person specifying auxiliary information as being information formed by enciphering the person specifying information,
the transmitting means transmits the person specifying information and the person specifying auxiliary information together with the answered data, and
the information processing unit further comprises a person specifying information reception judging means that judges whether the person specifying information and the person specifying auxiliary information are received or not and discontinues a subsequent process in case that both of the person specifying information and the person specifying auxiliary information are not received or either one of them is not received.

17. The personnel evaluation system described in claim 16, wherein the person specifying information reception judging means discontinues a subsequent process only on occasions when neither the person specifying information nor the person specifying auxiliary information is received and the information processing unit comprises an answered data tentative memorizing means that memorizes the answered data received by the receiving means in relationship with the received person specifying information or the received person specifying auxiliary information in case of either one of the person specifying information and the person specifying auxiliary information is received, and the data checking means that transfers corresponding answered data in the answered data tentative memorizing means to the answered data memorizing means in case that both of the person specifying information and the person specifying auxiliary information are received.

18. The personnel evaluation system described in claim 2, wherein even-numbered kinds of the data for answer are prepared.

19. An information processing unit, having an answered data memorizing means that memorizes answered data showing an answer to questionnaires inquiring performance capability of a work actually conducted in a job duty of an evaluation target person in relationship with an item identifier showing an item to which a job duty work inquired by the questionnaire belongs and an evaluation target person identifier showing an evaluation target person, a job duty performance capability value correspondence memorizing means that memorizes the answered data in relationship with the job duty performance capability value as being digitalized answered data, a job duty performance capability digitalizing means that memorizes the answered data memorized in the answered data memorizing means in relationship with the job duty performance capability value corresponding to the answered data based on a memorized content of the job duty performance capability value correspondence memorizing means, an item evaluation value calculating means that obtains the item evaluation value by summing up job duty performance capability values in relationship with an identical evaluation target person identifier and an identical item identifier, and an evaluation memorizing means that memorizes the item evaluation value obtained by the item evaluation value calculating means in relationship with the evaluation target person identifier and the item identifier, and the answered data shows evaluation shown by the stepwise performance capability.

20. The information processing unit described in claim 19, and further comprising a person specifying information reception judging means that judges whether person specifying information and person specifying auxiliary information are received or not and discontinues a subsequent process in case that both of the person specifying information and the person specifying auxiliary information are not received or either one of them is not received.

21. An information processing unit, comprising a selected input receiving means that receives a selected input of answered data showing an answer to a questionnaire inquiring a performance capability of a work actually conducted during a job duty of an evaluation target person through an input element, an answered data memorizing means that memorizes the answered data received by the selected input receiving means in relationship with an item identifier that shows an item to which the job duty work inquired by the questionnaire belongs and an evaluation target person identifier that shows the evaluation target person, a job duty performance capability value correspondence memorizing means that memorizes the answered data in relationship with a job duty performance capability value as being digitalized answered data, a job duty performance capability value digitalizing means that memorizes the answered data memorized in the answered data memorizing means in relationship with the job duty performance capability value corresponding to the answered data in the answered data memorizing means based on a memorized content of the job duty performance capability value correspondence memorizing means, and an item evaluation value calculating means that obtains an item evaluation value by summing up the job duty performance capability values in relationship with an identical evaluation target person identifier and an identical item identifier in the answered data memorizing means, wherein the answered data shows evaluation shown by the stepwise performance capability.

22. The information processing unit described in claim 21, and further comprising a person specifying information reception judging means that judges whether person specifying information and person specifying auxiliary information are received or not and discontinues a subsequent process in case that both of the person specifying information and the person specifying auxiliary information are not received or either one of them is not received.

23. A personnel evaluation program, as being a program to activate an information processing unit, to function as an answered data memorizing means that memorizes an answered data showing an answer inquiring a performance capability of a work actually conducted during a job duty of an evaluation target person in relationship with an item identifier that shows an item to which the job duty work inquired by the questionnaire belongs and an evaluation target person identifier that shows the evaluation target person, a job duty performance capability value correspondence memorizing means that memorizes the answered data showing the answer to the questionnaire inquiring the performance capability of the work actually conducted during the job duty of the evaluation target person in relationship with the job duty performance capability value as being digitalized answered data, a job duty performance capability value digitalizing means that memorizes the answered data memorized in the answered data memorizing means in relationship with the job duty performance capability value corresponding to the answered data in the answered data memorizing means based on a memorized content of the job duty performance capability value correspondence memorizing means, an item evaluation value calculating means that obtains an item evaluation value by summing up the job duty performance capability values in relationship with an identical evaluation target person identifier and an identical item identifier in the answered data memorizing means, an evaluation memorizing means that memorizes the item evaluation value obtained by the item evaluation value calculating means in relationship with the evaluation target person identifier showing the evaluation target person and the item identifier showing the item, and the evaluation outputting means that outputs the item evaluation value memorized in the evaluation memorizing means.

24. The personnel evaluation program described in claim 23, and making the information processing unit function also as a selected input receiving means that receives a selected input of the answered data showing an answer to a questionnaire inquiring a performance capability of a work actually conducted during a job duty of the evaluation target person through an input element that is to selectively input the answered data.

25. The personnel evaluation program described in claim 23, and making the information processing unit function also as a person specifying information reception judging means that judges whether person specifying information and person specifying auxiliary information are received or not and discontinues a subsequent process in case that both of the person specifying information and the person specifying auxiliary information are not received or either one of them is not received.
